(19) United States
(12) Patent Application Publication
(10) Pub. No.: US 2005/0041196 A1
(43) Pub. Date: Feb. 24, 2005

(54) Display apparatus

(75) Inventors: Shoichi Ishihara, Katano-shi (JP); Koichi Miyachi, Soraku-gun (JP)

Correspondence Address: NIXON & VANDERHYE, PC, 1100 N GLEBE ROAD, 8TH FLOOR, ARLINGTON, VA, 22201-4714, US

(73) Assignee: SHARP KABUSHIKI KAISHA, Osaka (JP)

(21) Appl. No.: 10/920,175

(22) Filed: Aug. 18, 2004

(30) Foreign Application Priority Data
Aug. 21, 2003 (JP) 2003-208243

(51) Int. Cl. C09K 19/02

(52) U.S. Cl. 349/181

(57) ABSTRACT

A dielectric liquid layer is sandwiched between a pixel substrate and a counter substrate, at least one of which is a transparent. The dielectric liquid layer is made from a liquid that is macroscopically isotropic and transparent, but has clusters microscopically, the clusters being agglomerations in each of which liquid crystal molecules are aligned in short distance order. Because of the presence of the cluster even at a temperature equal to or higher than the liquid crystal-isotropic phase transition temperature of a liquid crystal compound, reduction of the Kerr effect is suppressed even if the temperature rises. For example, clusters containing, for example, (a) a liquid crystal compound having an ability of forming an intermolecular hydrogen bond, (b) a liquid crystal compound having a smectic phase, (c) a particulate, (d) or the like, has a large cluster size and thus have a long life even if the temperature rises.

This Nonprovisional application claims priority under 35 U.S.C. §119(a) on Patent Application No. 2003/208243 filed in Japan on Aug. 21, 2003, the entire contents of which are hereby incorporated by reference.

### FIELD OF THE INVENTION

The present invention relates to a display apparatus which utilizes an electric-optical effect, preferably a secondary electro-optical effect, and thus has a high-speed response and a wide-viewing-angle display property.

### BACKGROUND OF THE INVENTION

Liquid crystal display elements are advantaged over other display elements in terms of its thin thickness, light weight, and low power consumption. The liquid crystal display elements are widely used in image display apparatuses such as televisions, video cassette recorders, and the like, and OA (Office Automation) apparatuses such as monitors, word processors, personal computers, and the like.

Conventionally known liquid crystal display methods of the liquid crystal display elements are, for example, the TN (Twisted Nematic) mode in which a nematic liquid crystal is used, display modes in which FLC (Ferroelectric Liquid crystal) or AFLC (Antiferroelectric Liquid crystal) is used, a polymer dispersion type liquid crystal display mode, and the like mode.

Among the liquid crystal display methods, for example, the TN (Twisted Nematic) mode in which the nematic liquid crystal is used is conventionally adopted in the liquid crystal display elements in practical use. The liquid crystal display elements using the TN mode have disadvantages of slow response, narrow viewing angle, and the like drawbacks. Those disadvantages are large hindrances for the TN mode to take over CRT (Cathode Ray Tube).

Moreover, the display modes in which the FLC or AFLC is used, are advantageous in their fast response and wide viewing angles, but significantly poor in anti-shock property and temperature characteristics. Therefore, the display modes in which the FLC or AFLC is used, have not been widely used practically.

Further, the polymer dispersion type liquid crystal display mode, which utilizes scattering of light, does not need polarizer and is capable of performing highly bright display. However, in principle, the polymer dispersion type liquid crystal display mode cannot control the viewing angle by using a phase plate.

In all those display methods, liquid crystal molecules are orientated in a certain direction and thus a displayed image looks differently depending on an angle between a line of vision and the liquid crystal molecules. On this account, all those display methods have viewing angle limits. Moreover, all the display methods utilize rotation of the liquid crystal molecules, the rotation caused by application of an electric field on the liquid crystal molecules. Because the liquid crystal molecules are rotated in alignment all together, responses take time in all the display method. Note that the display modes in which the FLC and the AFLC are used, are advantageous in the response speed and the viewing angle, but have such a problem that their alignment would be irreversibly destroyed by an external force.

On contrary to those display methods in which the rotation of the molecules by the application of the electric field is utilized, a display method in which the secondary electric-optical effect is utilized.

The electric-optical effect is a phenomenon in which a refractive index of a material is changed by an external electric field. There are two types of the electric-optical effect: one is an effect proportional to the electric field and the other is proportional to the square of the electric field. The former is called the Pockels effect and the latter is called the Kerr effect. Especially the Kerr effect has been adopted in high-speed optical shutters early on, and has been practically used in a special measurement instruments. The Kerr effect was discovered by J. Kerr in 1875. So far, inorganic crystals (LiNbO₃), and organic liquid such as nitrobenzene, carbon disulfide, and the like, are known as material showing the Kerr effect. Those materials are used, for example, in the aforementioned optical shutters, light modulation devices, light deflection devices, and the like devices. Further, those materials are used for measurement of strength of high electric fields for power cables and the like, and the like usage.

Later on, it was found that liquid crystal materials have a large Kerr constant. Researches on basic technology have been conducted to utilize the large Kerr constant of the liquid crystal materials for use in light modulation devices, light deflection devices, and further optical integrated circuit. It was reported that a liquid crystal compound has a Kerr constant more than 200 times higher than that of nitrobenzene.

Under those circumstances, studies for utilization of the Kerr effect in display apparatuses has been started. It is expected that the utilization of the Kerr effect attains relatively a low voltage driving because the Kerr effect is proportional to the square of the electric field. Further, it is expected that the utilization of the Kerr effect attains a high-response display apparatus because the Kerr effect shows a response property of several p seconds to several m seconds, as its basic nature.

Under those circumstances, a display apparatus in which the Kerr effect is utilized was suggested recently. The display apparatus is provided with: a pair of substrates, at least one of them being transparent; a medium held between the substrates, the medium containing polar molecules in an isotropic state; a polarizer provided in an external side of at least one of the substrates; and an electric-field-applying means for applying an electric field on the medium (for example, Japanese Unexamined Patent Application, Tokukai, Publication No. 2001-249363 (published on Sep. 14, 2001; Hereinafter refereed to as Reference 1).

It is known that in case where the liquid crystal material is used, the Kerr effect (which is observed when in the isotropic state) is largest in a vicinity of a liquid crystal phase-isotropic phase transition temperature, and decreases according to a function proportionally to 1/(T-T*) (where T* is a secondary phase transition temperature (critical temperature), as a temperature rises. The temperature dependency of the Kerr effect, that is, the temperature dependency of the Kerr constant of the liquid crystal material is a large problem to solve for practical use of the display apparatus using the Kerr effect.

Reference 1 attempts to solve the problem by adding a particular non liquid crystal material into a liquid crystal material so as to obtain a large Kerr effect within a practical temperature range by lowering an isotropic phase transition temperature of the liquid crystal material, but not by reducing temperature dependency of the Kerr effect.

As an attempt to reduce the temperature dependency of the Kerr effect, it has been tried to reduce, by confining a liquid crystal molecule in a polymer material, temperature dependency of the Kerr constant in an optical switch in which the Kerr effect is utilized (For example, Japanese Unexamined Patent Application, Tokukaihei, Publication No. 11-183937 (published on Jul. 9, 1999, corresponding to U.S. Pat. No. 6,266,109; Hereinafter referred to as Reference 2).

Specifically, Reference 2 suggests an arrangement of a liquid crystal optical switching device including a pair of substrates; a liquid crystal material held between the substrates and divided into sub-regions; and a polymer material for dividing a region of the liquid crystal material into the sub-regions, the liquid crystal optical switching device including: a medium, which is optically isotropic when no voltage is applied thereon, and shows an optical anisotropy proportional to square of an electric field strength when a voltage is applied; and a voltage applying means for applying the voltage onto the medium, wherein each sub-regions of the liquid crystal material has an average diameter of 0.1 μm or less.

However, the method described in Reference 2 requires polymerization of reactive monomer by using light or the like in order to divide the region of the liquid crystal material into the sub-regions. Further, in the method described in Reference 2, it is required that the sub-regions have a size of 0.1 μm or less. Those requirements and the like lead to very difficult production. Moreover, the method described in Reference 2 has a problem in reliability, because an area in which the liquid crystal material and the polymer material touch each other is large.

Note that, as described above, Reference 1 attains switching in the practical temperature range by lowering a heating temperature by lowering the isotropic transition temperature of the liquid crystal material. Thus, Reference 1 does not lower the temperature dependency of the Kerr constant itself.

Therefore, Reference 1 has a large desire for a display apparatus in which the temperature dependency of the Kerr constant is small and which can be produced with ease.

Therefore, there is a strong desire for a display apparatus which has a small temperature dependency of an electric-optical effect, typically the Kerr effect, and which can be easily manufactured.

### SUMMARY OF THE INVENTION

In order to solve the aforementioned problems, an object of the present invention is to provide a display apparatus, which has a smaller temperature dependency of an electro-optical effect, such as Kerr effect, and which can be manufactured easily.

In order to attain the object, a display apparatus according to the present invention, which includes (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, is so arranged that the dielectric liquid layer contains clusters at a temperature that is equal to or higher than a liquid crystal-isotropic phase transition temperature of the liquid crystal compound, and being transparent to visible light, the clusters formed by locally aligning liquid crystal molecules in the liquid crystal compound at the temperature that is equal to or higher than the liquid crystal-isotropic phase transition temperature of the liquid crystal compound.

More specifically, a display apparatus according to the present invention is, in order to attain the above object, arranged as follows, for example: the display apparatus, which includes (a) a dielectric liquid layer containing a liquid crystal compound whose refractive index is changed by an electric field applied thereon; and (b) an electric-field-applying member for applying the electric field onto the dielectric liquid layer, the display apparatus performing display operation by using a secondary electro-optical effect in which the refractive index is in proportion with square of the electric field, is so arranged that the dielectric liquid layer contains clusters at a temperature that is equal to or higher than a liquid crystal-isotropic phase transition temperature of the liquid crystal compound, and is transparent to visible light, the clusters formed by locally aligning liquid crystal molecules in the liquid crystal compound at the temperature that is equal to or higher than the liquid crystal-isotropic phase transition temperature of the liquid crystal compound.

As described above, the display apparatus of the present invention performs the display operation, for example, by utilizing the secondary electro-optical effect (Kerr effect) by using the change in the refractive index. In this display apparatus, the deviation of electrons in each molecule is controlled, thereby allowing to individually rotating the molecules that are randomly orientated. Thus, the display apparatus of this arrangement has a very fast responding speed. Further, the display apparatus has no viewing angle limit, because the molecules are randomly orientated.

Usually, as temperature rises, the liquid crystal compound transits from a liquid crystal phase having a short distance order, to an isotropic phase having random orientation of molecules. The Kerr effect is observed in a transparent medium that is transparent to incident light. The dielectric liquid layer used in the display apparatus according to the present invention is macroscopically liquid that is in the isotropic phase and is transparent. However, the dielectric liquid layer contains the clusters microscopically. The clusters are agglomerations of molecules that have short distance order. Note that in the present invention the clusters are used in a state at which they are transparent to the visible light, because the dielectric liquid layer is transparent to the visible light.

The display apparatus attains a large Kerr effect by the arrangement in which the dielectric liquid contains the clusters as described above. However, in case a conventional liquid crystal material is used, the Kerr effect decreases according to a function proportionally to 1/(T-T*), as the temperature rises. The inventors of the present invention, as a result of intensive studies, found that such large temperature dependency of the Kerr effect in the conventional liquid crystal material is mainly due to the size of the clusters that is large in a vicinity of a transparent point of the liquid crystal material but is abruptly reduced as the temperature rises. As a result of diligent works, the inventors of the present invention found that the temperature dependency of the electro-optical effect, such as the Kerr effect, can be reduced by arranging such that the dielectric liquid layer contains the clusters, which are formed by locally aligning liquid crystal molecules in the liquid crystal compound at the temperature that is equal to or higher than the liquid crystal-isotropic phase transition temperature of the liquid crystal compound.

With this arrangement, it is possible to reduce the temperature dependency of the electro-optical effect, such as the Kerr effect, thereby making it possible to provide a display apparatus having a wide viewing angle and a fast responding speed.

Further, with this arrangement, there is no need of having an arrangement for dividing regions of the liquid crystal materials into sub-regions, unlike in Reference 2. Thus, it is possible to provide a display apparatus that can be easily produced and has a high reliability.

Moreover, in order to attain the object, a display apparatus according to the present invention, which includes (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, is so arranged that the dielectric liquid layer is transparent to visible light and contains a liquid crystal compound having an ability of forming an intermolecular hydrogen bond.

More specifically, a display apparatus according to the present invention is, in order to attain the object, arranged as follows, for example: the display apparatus, which includes (a) a dielectric liquid layer containing a liquid crystal compound whose refractive index is changed by an electric field applied thereon, and (b) an electric-field-applying member for applying the electric field onto the dielectric liquid layer, the display apparatus performing display operation by using a secondary electro-optical effect in which the refractive index is in proportion with square of the electric field, is so arranged that the dielectric liquid layer is transparent to visible light and contains a liquid crystal compound having an ability of forming an intermolecular hydrogen bond.

Moreover, in order to attain the object, a display apparatus according the present invention, which includes (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, is so arranged that the dielectric liquid layer is transparent to visible light, and contains a liquid crystal compound having a smectic phase.

More specifically, a display apparatus according to the present invention is, in order to attained the object, arranged as follows, for example: the display apparatus according to the present invention, which includes (a) a dielectric liquid layer containing a liquid crystal compound whose refractive index is changed by an electric field applied thereon, and (b) an electric-field-applying member for applying the electric field onto the dielectric liquid layer, the display apparatus performing display operation by using a secondary electro-optical effect in which the refractive index is in proportion with square of the electric field, is so arranged that the dielectric liquid layer is transparent with respect to visible light, and contains a liquid crystal compound having a smectic phase.

Further, in order to attain the object, a display apparatus according to the present invention, which includes (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, is so arranged that the dielectric liquid layer is transparent to visible light, and contains a particulate having a particle diameter of 0.1 μm or less, the particulate dispersed in the dielectric liquid layer.

More specifically, a display apparatus according to the present invention is, in order to attain the object, arranged as follows, for example: the display apparatus according to the present invention, which includes (a) a dielectric liquid layer containing a liquid crystal compound whose refractive index is changed by an electric field applied thereon; and (b) an electric-field-applying member for applying the electric field onto the dielectric liquid layer, the display apparatus performing display operation by using a secondary electro-optical effect in which the refractive index is in proportion with square of the electric field, is so arranged that the dielectric liquid layer is transparent to visible light, and contains a particulate having a particle diameter of 0.1 μm or less, the particulate dispersed in the dielectric liquid layer.

Moreover, in order to attain the object, a display apparatus of the present invention, which includes, (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, is so arranged that the dielectric liquid layer is transparent to visible light; and a dielectric thin film is provided on at least one of surfaces of the dielectric liquid layer so that the dielectric thin film touches the at least one of the surfaces, the dielectric thin film containing a particulate having a particle diameter of 0.1 μm or less.

More specifically, a display apparatus according to the present invention is, in order to attain the object, arranged as follows, for example: the display apparatus according to the present invention, which includes (a) a dielectric liquid layer containing a liquid crystal compound whose refractive index is changed by an electric field applied thereon; and (b) an electric-field-applying member for applying the electric field onto the dielectric liquid layer, the display apparatus performing display operation by using a secondary electro-optical effect in which the refractive index is in proportion with square of the electric field, is arranged such that the dielectric liquid layer is transparent to visible light; and a dielectric thin film is provided on at least one of surfaces of the dielectric liquid layer so that the dielectric thin film touches the at least one of the surfaces, the dielectric thin film containing a particulate having a particle diameter of 0.1 μm or less.

The above-described display apparatuses according to the present invention are display apparatuses that perform the display operation by using, for example, the secondary electro-optical effect (Kerr effect) that utilizes the change in refractive index, as an electro-optical effect that utilizes the optical anisotropy. In such display apparatuses, by controlling the deviation of the electrons in each molecule, the molecules, which are randomly orientated, are individually rotated to change its direction. Thus, the display apparatuses has a very fast responding speed, and further has no viewing angle limit due the random orientation of the molecules.

The dielectric liquid layer used in the display apparatus according to the present invention is macroscopically liquid that is in the isotropic phase and is transparent. However, the dielectric liquid layer contains the clusters microscopically. The clusters are agglomerations of molecules that have short distance order.

With the arrangement in which the dielectric liquid layer contains the liquid crystal compound having the ability of forming the intermolecular hydrogen bond, the formation of the intermolecular hydrogen bond in the dielectric liquid layer gives the clusters a large cluster size. Thereby, it is possible to gives the clusters a longer life even if the temperature rises. Therefore, according to the arrangements, it is possible to provide a display apparatus in which the temperature dependency of the electric-optical effect such as the Kerr effect, is reduced, and which has a wide viewing angel and fast responding speed.

Moreover, the smectic liquid crystal compound has a strong intermolecular interaction. By arranging such that the dielectric liquid layer contains the smectic liquid crystal compound, it is possible to attain a large cluster size, thereby attaining a longer life of the cluster even if the temperature rises. Therefore, with the arrangements, it is possible to provide a display apparatus in which the temperature dependency of the electric-optical effect such as the Kerr effect, is reduced, and which has a wide viewing angel and fast responding speed.

Moreover, scattering of light is ignorable when the particle diameter is 0.1 μm or less, that is, when the particle diameter of particles is smaller than a wavelength of incident light. Thus, when the particle diameter of the particulate is 0.1 μm or less, the particulate is transparent with respect to the visible light.

When the dielectric liquid layer contains the particulate, it is easy for liquid crystal molecules to be adsorbed onto a surface of the particulate physically or chemically, thereby being oriented toward the particulate as a core. Thereby, clusters having a large cluster size are attained. The clusters thus have a long life, even if the temperature rises. Therefore, with the arrangements, it is possible to provide a display apparatus in which the temperature dependency of the electric-optical effect such as the Kerr effect, is reduced, and which has a wide viewing angel and fast responding speed.

Moreover, with an arrangement in which the particulate is contained in the dielectric thin layer provided on an internal surface of at least one of a pair of substrates, at least one of which is transparent, and which sandwich the dielectric liquid layer therebetween, that is, the particulate is contained in the layer provided adjacent to the dielectric liquid layer, it is easy for liquid crystal molecules to be adsorbed onto a surface of the particulate physically or chemically, so as to be oriented toward the particulate as a core. Thereby, clusters having a large cluster size are attained. The clusters thus have a long life, even if the temperature rises. Therefore, with the arrangements, it is possible to provide a display apparatus in which the temperature dependency of the electric-optical effect such as the Kerr effect, is reduced, and which has a wide viewing angel and fast responding speed.

Further, with any of those arrangements, there is no need of having an arrangement for dividing regions of the liquid crystal materials into sub-regions, unlike in Reference 2. Thus, it is possible to provide a display apparatus that can be easily produced and has a high reliability.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a cross-sectional view schematically showing an example of an arrangement of a display apparatus of one embodiment of the present invention.

FIG. 2 is an exploded perspective view schematically showing an arrangement of main parts of the display apparatus shown in FIG. 1.

FIG. 3 is an explanatory view showing an alignment process direction of a substrate that constitutes a cell of the display apparatus shown in FIG. 1.

FIG. 4 is a schematic diagram showing an arrangement of a measurement system for Kerr constant.

FIG. 5 is a schematic diagram showing a change of orientation of liquid crystal according to temperature rise.

FIG. 6 is a schematic diagram showing a length of an optical path in an arrangement in which a comb-like shaped electrode is used in the display apparatus shown in FIG. 1.

FIG. 7 is a graph showing a result of measurement of temperature dependency of Kerr constant of a dielectric liquid used in the embodiment of the present invention.

FIG. 8 is a graph showing a result of measurement of temperature dependency of Kerr constant of a dielectric liquid used in another embodiment of the present invention.

FIG. 9 is a graph showing a result of measurement of temperature dependency of Kerr constant of a dielectric liquid used in still another embodiment of the present invention.

FIG. 10 is a graph showing a result of measurement of temperature dependency of Kerr constant of a dielectric liquid used in yet another embodiment of the present invention.

FIG. 11 is a graph showing a result of measurement of temperature dependency of Kerr constant of a dielectric liquid used in still yet another embodiment of the present invention.

### DESCRIPTION OF THE EMBODIMENTS

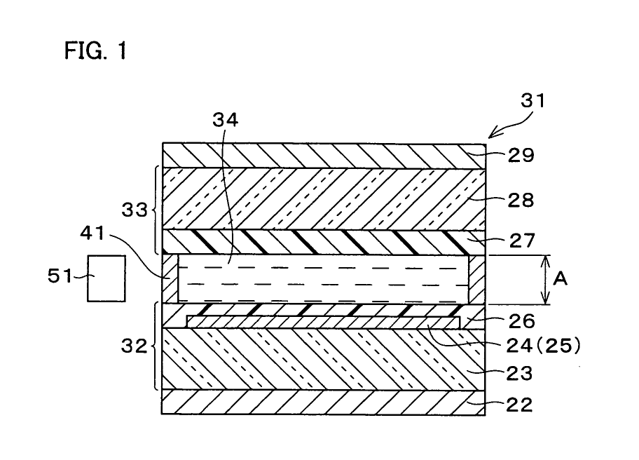

Embodiments of the present invention are described below, referring to FIGS. 1 to 11.

A display apparatus according to a present embodiment is provided with a display element constituted by holding, between a pair of substrates, at least one of which is transparent, a dielectric liquid containing a liquid crystal compound being optically isotropic when no voltage is applied thereon, and having optical anisotropy (refractive index, degree of order of alignment) that is changeable by application of an electric field thereon, wherein display operation is carried out by changing the optical anisotropy by application of an electric field. Specifically, for example, a display apparatus according to a present embodiment is so arranged that the dielectric liquid contains, as the liquid crystal compound, a liquid crystal compound whose refractive index is changed by the application of the electric field, and the display operation is carried out by utilizing an electric-optical effect, preferably, a secondary electric-optical effect (that is, the Kerr effect) in which the refractive index is changeable proportionally to square of the electric field by the application of the electric field. The following specifically describes the display apparatus of the present embodiment.

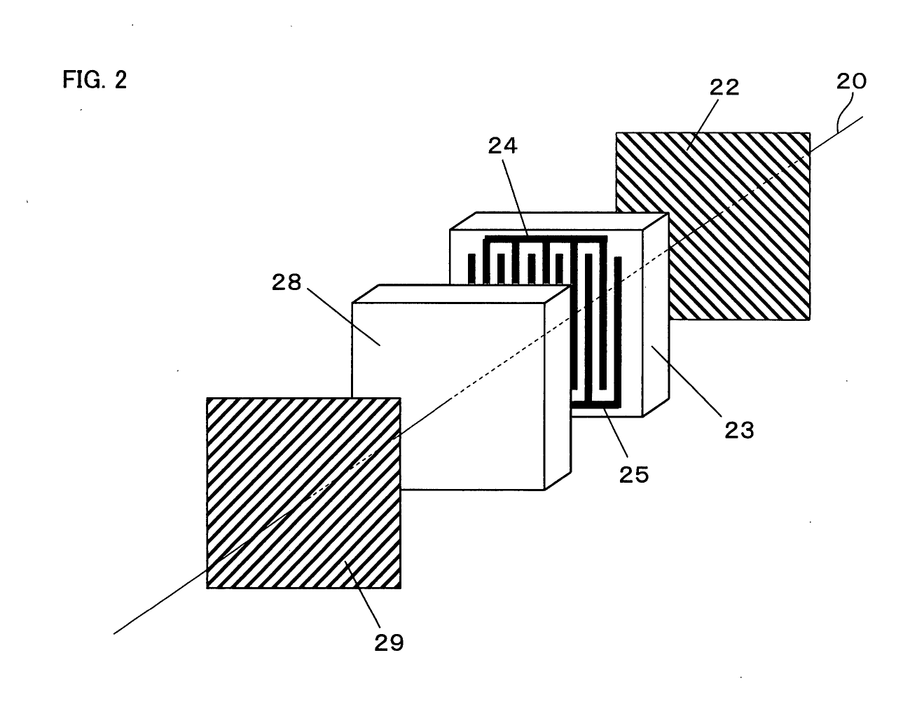

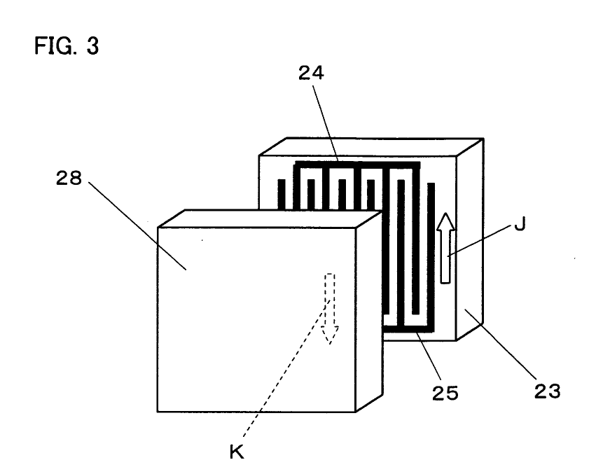

FIG. 1 is a cross-sectional view schematically showing an example of an arrangement of the display apparatus of the present embodiment. FIG. 2 is an exploded perspective view schematically showing essential parts of the display apparatus shown in FIG. 1. Moreover, FIG. 3 is an explanatory view showing a direction of an alignment process for a substrate that constitutes the cell of the display apparatus shown in FIG. 1.

As shown in FIG. 1, the display apparatus of the present embodiment is provided with a cell 31, and if necessary a heater 51. The cell 31 serves as a display element, whereas the heater 51 serves as a heating means (heating member).

The cell 31, as shown in FIG. 1, is provided with: a pair of substrates (hereinafter, respectively called as a pixel substrate 32 and a counter substrate 33), at least one of the substrate being transparent; a dielectric liquid layer 41 held between the substrates; and further a polarizer on an external side of at least one of the substrate external side is that side of the substrate not facing toward the other substrate). The cell 31 shown in FIGS. 1 and 2 is so arranged that a polarizer 22 is provided on the external side of the pixel substrate 32 and a polarizer 29 is provided on an external side of the counter substrate 33.

Of the pair of substrates, the pixel substrate 32 is, as shown in FIGS. 1 and 2, provided with (a) comb-like shaped electrodes 24 and 25 and (b) a transparent substrate 23 (for example a glass substrate or the like) on which the comb-like shaped electrodes 24 and 25 are provided, the comb-like shaped electrodes 24 and 25 facing each other and serving as electric-field-applying means (electric-field-applying member) for applying an electric field on the dielectric liquid layer 41. If necessary, the pixel substrate 32 is provided with a dielectric thin film 26 (alignment film), having been subjected to a rubbing treatment, and being so formed as to cover the comb-like shaped electrodes 24 and 25.

The comb-like shaped electrodes 24 and 25 are. not particularly limited in terms of a line width and an inter-electrode gap between the electrodes 24 and 25. The line width and the gap of the electrodes 24 and 25 may be arranged arbitrarily, for example, in accordance with a gap A (see FIG. 1) between the pixel substrate 32 and the counter substrate 33. Note that, as an example, the present embodiment is so arranged that the gap A is 10 μm and the line width and the inter-electrode of the comb-like shaped electrodes 24 and 25 are 10 μm. Those numerical values are to merely exemplify the arrangement, and not to limit the present invention. Moreover, various materials conventionally well-known as materials for electrode may be used as a material, from which the comb-like shaped electrodes 24 and 25 is made. For example, a transparent electrode material such as ITO (Indium Tin Oxide) and the like, a metal electrode material such as aluminum and the like, and the like materials may be used as the material.

On the other hand, the counter substrate 33, which is provided to face the pixel substrate 32 with the dielectric liquid layer 41 sandwiched therebetween, is provided with a transparent substrate 28 such as a glass substrate or the like, and if necessary a dielectric thin film 27 (alignment film) on the transparent substrate 28, the dielectric thin film 27 having been subjected to rubbing treatment.

Rubbing treatment is carried out for (a) the substrates 28 on which if necessary the dielectric thin film 27 is provided, and (b) the substrate 23 on which the comb-like shaped electrodes 24 and 25 are provided and if necessary the dielectric thin film 26 is so provided as to cover the comb-like shaped electrodes 24 and 25. In the rubbing treatment, surfaces of the substrates 28 and 23 are rubbed respectively in opposite directions along “teethes” of the comb-like shaped electrodes 24 and 25, as shown in FIG. 3. Then, the substrates 23 and 28 are bonded together by using a sealing agent 34, with a space (not shown) such a glass fiber spacer or the like interposed therebetween. After that, a dielectric liquid is introduced into a gap formed between the substrates 23 and 28. In this way, the dielectric liquid layer 41 is formed. The dielectric liquid layer 41 will be later described.

There in no particular limitation in the dielectric thin films 26 and 27 used in the display apparatus according to the present embodiment. For example, an alignment film made of an alignment material such as polyimide or the like may be used as the dielectric thin films 26 and 27. Note that the dielectric thin films 26 and 27 is not limited to polyimide, provided that the dielectric thin films 26 and 27 have a function of aligning liquid crystals. The dielectric thin film 26 and 27 provided on the surface of the pixel substrate 32 and the counter substrate 33 may be respectively an organic film or an inorganic film, or may not be provided. In case where the dielectric thin films 26 and 27 are provided, effect of providing the dielectric thin films 26 and/or 27 can be attained by providing at least one of the dielectric thin films 26 and 27 on an internal surface of at least one of the substrate, for example, on the comb-like shaped electrodes 24 and 25 on the pixel substrates 32. There is no particular limitation in film thickness of the dielectric thin films 26 and 27.

However, it is possible to improve a degree of order of the alignment of the liquid crystal molecules by arranging the display apparatus to include the dielectric thin films 26 and 27, which are preferably organic films, and especially preferably films made of polyimide. The improvement in the degree of the order of the alignment of the liquid crystal molecules makes it possible to have a larger Kerr effect. Especially, the arrangement in which the dielectric thin films 26 and 27 are organic thin films gives a good effect on the alignment. Particularly, the arrangement in which the dielectric thin films 26 and 27 are made of polyimide gives a quite excellent effect on the alignment. Those arrangements make it possible to attain a larger Kerr effect. Moreover, the use of polyimide makes it possible to provide a display apparatus having a good display performance, because polyimide is highly stable and has a high reliability. The dielectric liquid used in the present embodiment will be described later.

The heater 51 is used for causing isotropic transition of the liquid crystal compound, in case the dielectric liquid layer 41 is formed from the liquid crystal compound having an isotropic transition temperature higher than usage environment temperature, that is, room temperatures. The heater 51 is not necessary if at the usage environment temperature the liquid crystal compound is optically transparent with respect to visible light (light within the visible light range) and is an isotropic liquid when not voltage is applied thereon. The heater 51 is not particularly limited in terms of where it is located and how it is configured, provided that the heater 51 can heat the dielectric liquid layer 41. Note that in the present embodiment, if something is described merely as “transparent”, it is meant that something is transparent to the visible light.

The dielectric liquid for use in the display apparatus according to the present embodiment is used in a transparent state. In order to cause the liquid crystal compound to be on or above the transparent point, the cell 31 may be heated, for example, by using (1) a heater (for example, a heating means (heating member) such as the heater 51 or the like, shown in FIG. 1) provided in a vicinity of the cell 31 (liquid crystal cell), or by utilizing (2) heat conduction from a backlight and/or a periphery driving circuit (in this case the backlight and/or the periphery driving circuit functions as the heating means (heating member)), or by using (3) the like means. Moreover, the cell 31 may be provided with a sheet-like shaped heater (heating means, heating member) stuck thereon, for heating the cell 31 to a predetermined temperature. Further, in order to use the dielectric liquid in a transparent state, it may be arranged to use a liquid material having a transparent point lower than a lower limit of a usage temperature range of the display apparatus.

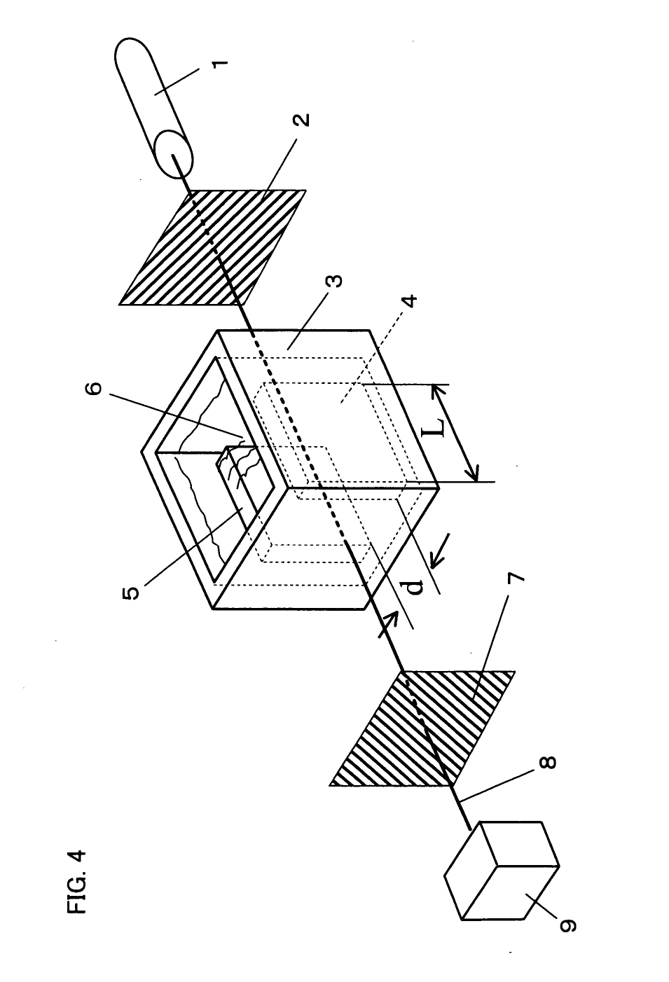

The following explains a fundamental principle of display performed by the display apparatus of the present embodiment, referring to FIG. 4.

FIG. 4 is a schematic view showing an arrangement of a measuring system for the Kerr constant, schematically. Correspondence between the sections shown in FIGS. 1 and 2, and those shown in FIG. 4 is as follows: the pair of substrates (the pixel substrate 32 and counter substrate 33) facing each there via the gap A corresponds to cell 3, the comb-like shaped electrodes 24 and 25 correspond to electrodes 4 and 5, the dielectric liquid layer 41 corresponds to a dielectric liquid 6 in the cell 3, the polarizers 22 and 29 correspond to a polarizer 2 and a light analyzer 7, and a light beam 20 corresponds to a light beam 8.

FIG. 4, the cell 3 including, inside thereof, (i) the pair of electrodes 4 and 5 facing each other and (ii) the dielectric liquid 6 is supplied with power from a modulation power source (not shown). Moreover, the polarizers (polarizer 2 and light analyzer 7 in FIG. 4) respectively provided on external sides of the cell 3 have polarization axes crossing each other at right degrees. The polarizer 2 and the light analyzer 7 are so arranged that said their polarization axes make 45 degrees with respect to a direction (electric field application direction) in which an electric field is applied on the cell 3. When no electric field is applied on the cell 3, the dielectric liquid 6 is isotropic. Thus, the light beam 8, without changing its polarization direction, passes through the cell 3. Because of this, the light beam 8 does not reach a detector 9 due to the arrangement of the polarizer 2 and the light analyzer 7. When the electric field is applied on the cell 3, the dielectric liquid 6 shows birefringence thereby making a difference between a refractive index of the electric field application direction, and a refractive index of a direction perpendicular thereto. Thus, light beams traveling in the respective directions have different phases, thereby causing a phase difference. Because of this, the light beam 8 generally becomes an elliptically polarized light beam after passing the cell 3. Thus, part of components of the light beam 8 can pass the light analyzer 7 after the light beam 8 passes through the cell 3, whereby the light beam 8 reaches the detector 9.

When the phase difference becomes n radian (equivalent to a half-wave length), the light beam 8 having passed the cell 3 changes to a linearly polarized light beam having the same polarization direction as the light analyzer 7, and substantially 100% of the light beam 8 reaches the detector 9. A voltage applied on the cell 3 when this happens is called a half-wave length voltage (V_{π}).

The following provides more detailed explanation. The Kerr constant is a constant indicative of a magnitude of the secondary electric-optical effect. When an electric field E is applied onto a liquid crystal compound in an isotropic state, birefringence is caused in the liquid crystal compound. A relationship between, a birefringence change (Δn=n//−n⊥) and an external electric field, that is, electric field E (V/m) is represented by the following Equation (1):
Δn=BλE² (1),
where n// is a refractive index in an electric field direction, n⊥ is a refractive index in a direction perpendicular to the electric field direction, B is Kerr constant (m/V²), and λ is a wavelength (m) of an incident light beam in vacuum.

As shown in FIG. 4, when the linearly polarized light beam enters the cell 3 via the polarizer 2, the linearly polarized light beam having a plane of polarization tilted by 45 degrees toward the electric field direction after passing the polarizer 2, a phase difference Γ is caused at an end of the cell 3, the phase difference Γ satisfying the following Equation (2), relating to the electric field direction and the direction perpendicular to the electric field direction:
Γ=2πLΔn/λ (2),
where L (m) is a length of a light path running through a material in which birefringence is caused by an electric field, Δn is the change in refractive index, λ is the wavelength (m) of an incident light beams in vacuum. In the measuring system shown in FIG. 4, L is equal to those lengths (m) of the electrodes 4 and 5, which are along a passing direction of the light beam (light beams passing direction) in the cell 3.

Because of this, the light beam having passed through the cell 3 becomes an elliptically polarized light beam that follows Equation (2). This allows part of the light beam to pass through the light analyzer 7 (polarizer). Part of the elliptically polarized light beam passes through the light analyzer 7 as a linearly polarized light beam. Here, a strength (I) of the light thus transmitted is represented by the following Equation (3):
I=I₀ sin²(Γ/2) (3),
where Iₒ is intensity of the incident light beam.

When no electric field E is applied on the cell 3, Γ=0 if a ordinary refractive index is compensated. Thus, from Equation (3), I=0. However, when an electric field is applied on the cell 3, Γ=π. In this case, I=I₀ from Equation (3). Thus, it becomes possible to carry out 100% light intensity modulation. A voltage applied here, that is a voltage necessary for the 100% light intensity modulation is called a half-wave length voltage (V_{π}.). On the other hand, because E=V/d (where d (m) is a distance between the electrodes), the phase difference Γ is represented by the following Equation (4), from Equations (1) and (2):
Γ=2πBV²(L/d²) (4).
Putting Γ=π, the half-wave length voltage V_{π} is obtained by the following Equation (5):
V_{π}=d/(2LB)^{0.5} (5).

Therefore, the Kerr constant B is obtained by the following Equation (6), which is obtained by modifying Equation (5):
B=d²/2LV_{π}² (6).

For example, in case where 4′-n-pentyl-4cyanobiphenyl is sealed in the cell 3 and is adjusted to a temperature of 33.3° C., which is near a nematic-isotropic phase transition temperature, a He-Ne laser beam (633nm) is used as the light beam 8 (modulated light beam), an output of the detector 9 reaches its maximum when a voltage of 517V is applied on the cell 3. This value indicates that the optical phase difference reaches a π radian, and corresponds to the half-wave length voltage V_{π}. Kerr Constant B of 4′-n-pentyl-4cyanobiphenyl is found to be 1.87×10⁻⁸ cm/V², by calculating Equation (6) with an actually measured half-wave length voltage V_{π} at which I=I₀, where an electrode gap in the cell 3 was 1 mm, and an electrode length L in an light beam passing direction was 10 mm.

Hereinafter, in the present embodiment, the Kerr Constant B is obtained by actually measuring the half-wave length voltage V_{π} at which I=I₀, and calculating Equation (6) with the actually measured half-wave length voltage V_{π}.

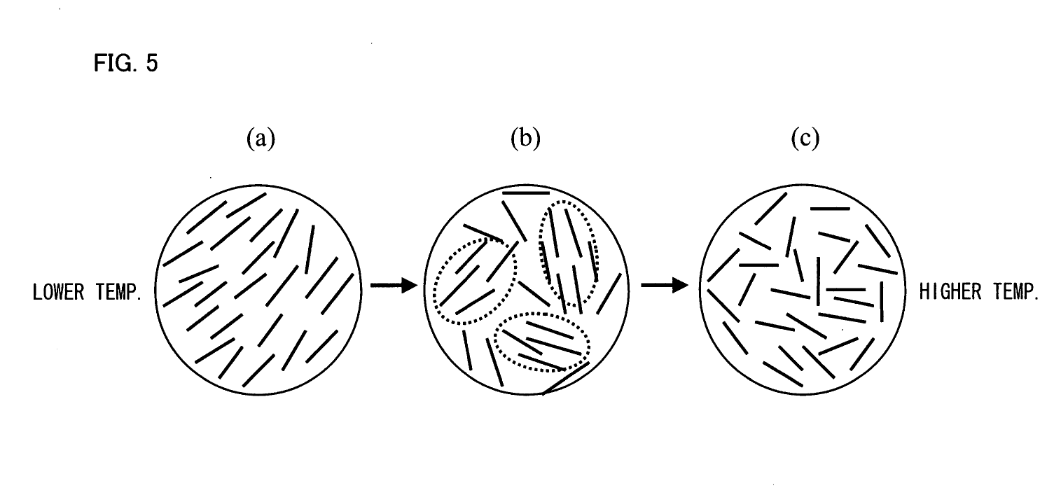

Because the Kerr effect is proportional to the square of the electric field, it is expected to attain, as described above, a relatively low voltage driving. Further, it is expected to attain a responding property of several μseconds to several m seconds, as a basic nature. The liquid crystal itself is a liquid having a short distance order as shown in FIG. 5(a). The alignment of the liquid crystal compound changes, as a temperature rises, from a liquid crystal phase state as shown in FIG. 5(a) in which the short distance order is present, via a state as shown in FIG. 5(b) in which the degree of the alignment order decreases, finally to a state as shown in FIG. 5(c) in which the molecules are orientated randomly. Note that FIGS. 5(a) to 5(c) are views schematically showing the change of the liquid crystal alignment as the temperature rises. FIG. 5(a) shows the liquid crystal phase state. FIG. 5(c) shows the state in which the molecules are randomly orientated. FIG. 5(b) shows the state of the alignment that is intermediate between the state shown in FIG. 5(a) and the state shown in FIG. 5(c).

In the present embodiment, the liquid crystal compound is used as a macroscopically isotropic and transparent liquid that has clusters (partial alignment of molecules as surrounded by the dotted lines in FIG. 5(b); that is, clusters are agglomeration of the liquid crystal molecules in which the liquid crystal molecules are locally aligned individually in each cluster.). Note that the cluster in the present embodiment is that association of the molecules of the liquid crystal compound which is formed in the dielectric liquid 6. Thus, microscopically the dielectric liquid 6 used in the present embodiment contains molecule associations having short distance orders in which the molecules are aligned in a certain direction, whereas macroscopically the dielectric liquid 6 shown an isotropic phase.

As described above, the present embodiment is so arranged as to use the liquid crystal compound in the liquid state in which the liquid crystal compound is isotropic and transparent macroscopically, instead of the liquid crystal compound in the liquid state in which the liquid crystal compound has the short distance order as shown in FIG. 5(a) as in the conventional liquid crystal display apparatus. Because of this, by controlling deviation of electrons in individual molecules, it is possible to individually rotate the molecules that are randomly orientated. Further, because the molecules are randomly orientated, there is no viewing angle limit. Thus, it is possible to provide a display apparatus having a high-speed response property and a wide viewing angle.

Note that the material showing the Kerr effect is, in principle, isotropic optically. However, if the material is subjected to the rubbing treatment or the like whereby the dielectric liquid layer 41 is aligned, the liquid crystal molecules are grouped into and act as a cluster in a vicinity of a boundary portion of the dielectric liquid layer 41 even at a temperature at which the dielectric liquid layer 41 becomes, in principle, isotropic so that the liquid crystal molecules are randomly orientated (here, the dielectric liquid layer 41 is macroscopically isotropic at the temperature). Therefore, it is possible to attain a large Kerr constant B apparently.

The present embodiment is so arranged that a high temperature is kept by temperature control by using, for example, the heater 51 (see FIG. 1), in order to use the liquid crystal compound as a liquid transparent to the visible light at the usage environment temperature (room temperatures). However, the present invention is not limited to this. For example, in order to use the liquid crystal compound as a liquid transparent to the visible light at the usage environment temperature (room temperatures), the present invention may be so arranged that the liquid crystal compound is in a form of minutes droplets having a diameter smaller than the wavelength of the light (for example, the liquid crystal compound may be so arranged as to have a diameter of 0.1 μm or less). With this arrangement, scattering of the light is suppressed. Alternatively, the present invention may be so arranged as to use a liquid crystal compound that is transparent and isotropic at the usage environment temperature (room temperatures).

As described above, the Kerr effect has such relationship that the change Δn of the refractive index of the material is proportional to square of the electric field E. In general, the direction (electric-field direction) in which the electric field E is applied is parallel to the direction of a resultant birefringence anisotropy. Therefore, in order to extract an optical signal from the change Δn of the refractive index of the material, it is necessary to have, for example, an optical arrangement in which the electric-field direction is positioned to perpendicularly cross the direction (traveling direction) in which the light travels. In an ordinary display apparatuses, in which the light passes the cell in a direction perpendicular to a surface of the substrate, it is necessary that the electric-field direction be parallel to the surface of the substrate.

One of methods of applying the electric field E parallel to the surface of the substrate is, for example., to provide the comb-like shaped electrodes 24 and 25 as the electric-field-applying means (electric-field-applying member) on an interior surface of one of the pair of substrates. With the arrangement in which the comb-like shaped electrodes 24 and 25 are so provided on one (pixel substrate 23) of the substrates that the comb-like shaped electrodes 24 and 25 face each other, it is possible to extract, as a change in the optical signal, the birefringence anisotropy generated by the application of the electric field.

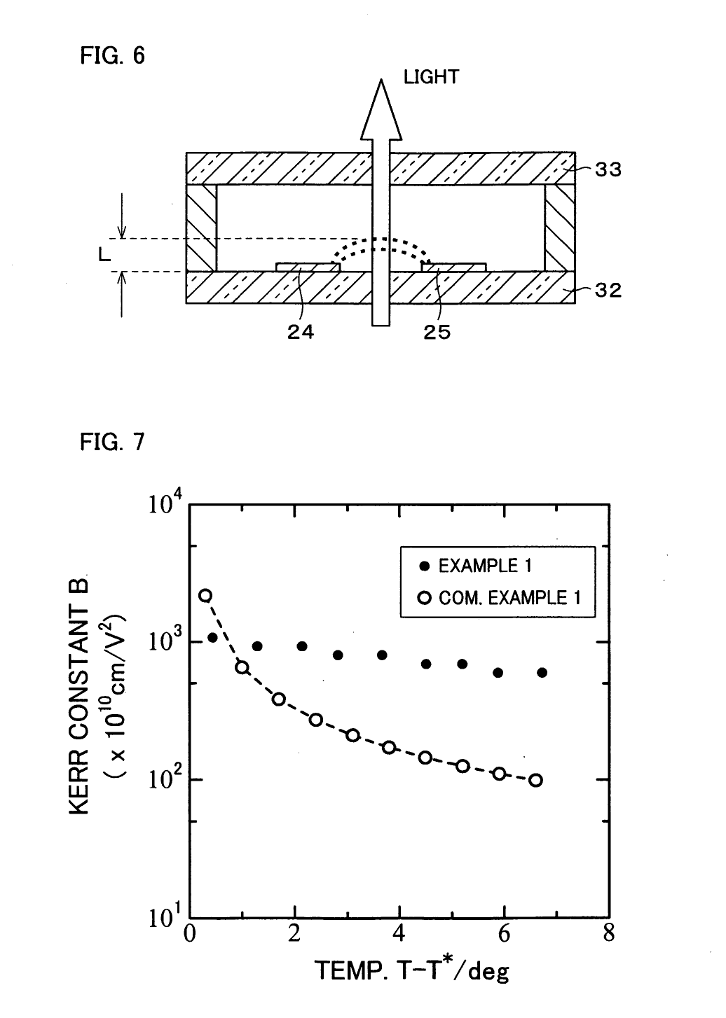

However, in the arrangement in which, in order to apply the electric field E parallel to the traveling direction of the light, the comb-like shaped electrodes 24 and 25 are so provided on one (pixel substrate 23) of the substrates that the comb-like shaped electrodes 24 and 25 face each other, an optical path length L, that is, a range within which electric fluxes from the comb-like shaped electrodes 24 and 25 reach, is not so large with respect to a thickness of the arrangement (the substrates sandwiching the liquid crystal layer) as shown in FIG. 6. On this account, it is impossible to have a large optical path length L in this kind of arrangement. Thus, in this arrangement, it is desirable to arrange such that the dielectric liquid layer 41 is made from a dielectric liquid 6 (see FIG. 4) having a large Kerr effect. In view of this, it is desirable that the liquid crystal compound to form the dielectric liquid layer 41 is used in such a state that the liquid crystal compound has a Kerr constant B as large as possible.

The Kerr effect of the liquid crystal is a phenomenon that appears, not in a liquid in the nematic phase, but in a liquid in an isotropic state at a temperature at or above its liquid crystal phase-isotropic phase transition temperature (primary transition temperature Tc). As shown in FIGS. 5(a) to 5(c), the liquid crystal compound, that is, the isotropic state of the liquid crystal material is attained when the usage environment temperature (heating temperature) attained by the heat application is high.

However, on the other hand, it is known that the Kerr effect (which is observed in the isotropic state) is largest in the vicinity of the liquid crystal phase-isotropic phase transition temperature, and that the Kerr effect decreases according to a function proportionally to 1/(T-T*), as the temperature rises. Note that T* is a secondary liquid crystal phase-isotropic transition temperature (critical temperature). In general, T*<Tc. Specifically, T* is lower that the transparent point by 1° C. to 2° C.

For this reason, in order that the liquid crystal compound for use in the dielectric liquid layer 41 may be used with a Kerr constant B as large as possible, it is necessary to strictly control the temperature.

Moreover, as seen from Equation (6), the temperature dependency of the Kerr constant B directly relates to the half-wave length voltage V_{π}, that is, a temperature dependency of the driving voltage. For voltage variation in a range of about ±15%, a practically-used display apparatus may be configured by using (a) a circuit for compensating for temperature variation (b) a circuit for monitoring an electric characteristics of a pixel, and for feeding back a result of the monitoring to a driving voltage value, or (c) the like circuit. The driving voltage variation in a range of about ±15% corresponds to variation of value of the Kerr Constant B in a range of about ±15%. In the other words, it is important how to expand a temperature range in which the variation in the Kerr constant B is ±30% from a center value thereof. Needless to say, if the Kerr constant B is sufficiently large and the driving voltage is 100V or less, it may be allowed that the Kerr constant B varies in a wider variation range.

Therefore, it is important for practical use to improve the liquid crystal material in terms of the temperature dependency of the Kerr effect.

The inventors of the present invention consider that the formation of the clusters, which are partial alignments of molecules as shown in FIG. 5(b), accounts for the large Kerr effect of the liquid crystal material. Actually, a Kerr constant B in molecules having no such cluster is smaller than that in the liquid crystal material by two digits. As a result of intensive studies, the inventors of the present invention found out that the large temperature dependency of the Kerr effect in the liquid crystal material is mainly due to that, in an ordinary liquid crystal material, the clusters are large in the vicinity of the transparent point of the liquid crystal material but becomes smaller as the temperature rises. Based on this finding, the inventors found that prolongation of the life of the cluster reduces the temperature dependency of the Kerr effect.

The intensive studies conducted by the inventors showed that specific examples of ways of prolonging the life of the clusters in the present embodiment are: (i) to enlarge a size of the clusters while giving a larger intermolecular force to the clusters, or (ii) to add, into the dielectric thin films 26 and 27, a material to be cores of the clusters, for making it easy to form the clusters, the dielectric thin films 26 and 27 being to be in touch with the dielectric liquid layer 41 made of the dielectric liquid 6.

Here, specific methods for (i) are, for example:
(1) to add in the dielectric liquid 6 a liquid crystal compound having an ability of forming an intermolecular hydrogen bond;
(2) to add in the dielectric liquid 6 a liquid crystal compound having a smectic phase; and
(3) to add in the dielectric liquid 6 a liquid crystal compound having an ability of forming a complex.

Moreover, specific methods for (ii) are, for example:
(4) to add in the dielectric liquid 6 a particulate to be cores for the clusters; and
(5) to add, into the dielectric thin films 26 and 27, a particulate to be cores of the clusters, for making it easy to form the clusters, the dielectric thin films 26 and 27 being to be in touch with the dielectric liquid layer 41 made of the dielectric liquid 6.

However, regardless of using any of the methods, the display apparatus according to the present embodiment is so arranged that the dielectric liquid 6 is used in a liquid state in which the dielectric liquid 6 is transparent with respect to the visible light at the usage environment temperature.

The Kerr effect is observed in a medium transparent to an incident light beam. When a light beam enters a medium, transmission, absorption, or reflection takes place. In general, non-transparent particles are dispersed into a transparent medium, light is absorbed or reflected (scattered). In this case, whether or not the light is transmitted depends on whether or not the light is scattered, if the particles do not absorb the light in the visible light range.

In general, Mie scattering occurs when the particles have a particle diameter larger than a wavelength of the incident light beam, whereas Rayleigh scattering takes place when the particles have a particle diameter of 1/10 or less of a wavelength of the incident light beam. However, in case where the length of the optical path is sufficiently short as in the display apparatus according to the present embodiment, the scattering that occurs when the diameter of the particles is smaller than the wavelength of the light beam is ignorable. Therefore, if the diameter of the particles (more exactly to say, a length of a longitudinal axis of the clusters) is 0.1 μm or less, it may be said that the medium is “transparent”.

Therefore, in order to maintain the dielectric liquid 6 in the liquid state in which the dielectric liquid 6 is transparent at the usage environment temperature, it is arranged, for example, that the size of the clusters (diameter, to say more exactly, the length of the longitudinal axis of the clusters) is 0.1 μm or less, preferably, 0.08 μm or less.

Hereinafter, display apparatuses of the present embodiment are described in more details.

To begin with, a display apparatus in which a dielectric liquid 6 containing a liquid crystal compound having the ability of forming an intermolecular hydrogen bond is used. Note that the arrangement and the display principle of the display apparatus itself are as described above. Therefore, the following mainly explains the dielectric liquid 6 for use in the display apparatus.

The intermolecular hydrogen bond is a bond formed, via a hydrogen atom, between atoms that are more electronegative than the hydrogen atom, the atoms belonging to other molecules. This kind of hydrogen bond is formed between (a) a slightly acidic hydrogen atom of OH, NH, or the like, and (b) (i) a negative atom having a large eletronegativity, (ii) an unsaturated bond, (iii) a benzene ring, (iv) or the like. In the present embodiment, for example, negative atoms having large electronegativities (halogens such as Cl, F, and the like), and polar molecules in which a hydrogen atom/hydrogen atoms bonds with O, N, P, S, Se, and/or the like, are used as the liquid crystal compound having the ability of forming the intermolecular hydrogen bond.

The liquid crystal compound is not particularly limited in terms of a functional group having the ability of forming the hydrogen bond. For example, the function group may be, for example, a hydroxyl group, a carboxyl group, a carbonyl group, an ether group, an amino group, an imino group, a sulfone group, a phosphonic acid group, and/or the like group. The liquid crystal compound may contain one functional group solely, or may contain two or more functional groups. That is, the liquid crystal compound is required to have at least the ability of forming the intermolecular hydrogen bond.

More specific examples used in the present embodiment as the liquid crystal compound having the ability of forming the intermolecular hydrogen ability are: 4-n-hexyloxy benzoic acid, 4-(4-octyloxy phenylethynyl)pyridine, p-cyanobenzal-p-amino benzoic acid, and p-n-amyl benzoic acid respectively having the following structural formulae (1) to (4), and the like compounds:

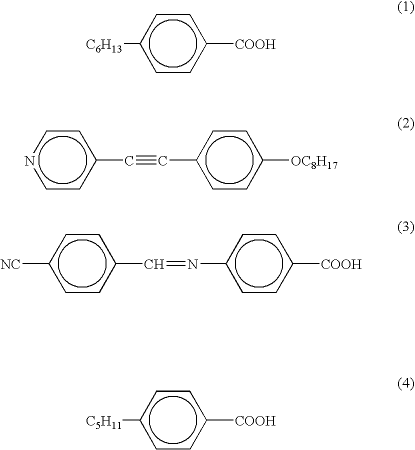

Moreover, besides the above compound, the following liquid crystal compounds may be used in the present embodiment as the liquid crystal compound having the ability of forming the intermolecular hydrogen bond: ω-n-alkyl sorbic acid, p-n-alkoxy-m-halogen benzoic acid, p-substituted polyoxy benzoic acid, trans-p-n-alkoxyl cinnamic acid, p′-n-alkoxy-p-biphenyl carboxylic acid, 7-n-alkoxy-2-fluorene acid, 6-n-alkoxy-2-naphalic acid, which are respectively represented by the following structural formulae (5) to (11), and their derivatives; 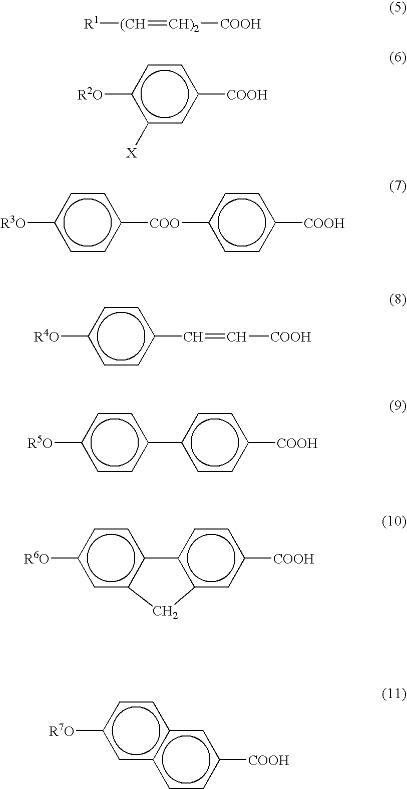
phenol derivates represented by structural Formulae (12) and (13); a compound represented by Structural Formula (14). 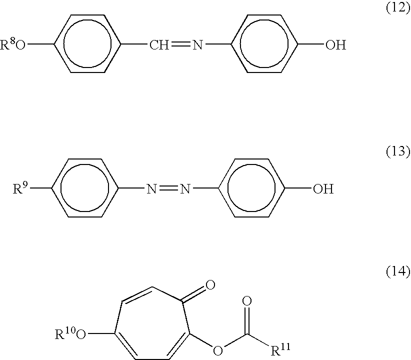
Note that each of R¹ to R¹¹ in Formulae (5) to (14) is independently an alkyl group having one to twelve carbon atoms. Moreover, X in Structural Formula (6) is a halogen group.

Those liquid crystal compounds having the ability of forming the intermolecular hydrogen bond may be used solely, or two or more of them may be used in combination in an appropriate manner. Those liquid crystal compounds having the ability of forming the intermolecular hydrogen bond have a large intermolecular interaction and thus are able to form large clusters. Among those liquid crystal compounds, the liquid crystal compound having a hydroxyl group in its molecular structure is especially suitable: because it is easy to obtain; its has a short bonding distance between the hydroxyl group and the hydrogen atom; it thus has a large bonding energy, that is, a large intermolecular interaction, and can prolong the life of the clusters even if the temperature rises. Note that the hydroxyl group may be a hydroxyl group in a phenyl group or a hydroxyl group in an alcohol group. In the present embodiment, the liquid crystal compound having a hydroxyl group is any liquid crystal compound (including a liquid crystal compound having a carbonyl group) that has a hydroxyl group in its molecular structure.

Moreover, the liquid crystal compound having the ability of forming the intermolecular hydrogen bond may be used, as the dielectric liquid 6, in combination with the following compounds or the like: p-butoxybenzylidene-cyanoanilline, p-hexyloxybenzylidene-cyanoanilline p-octyoxybenzyidene-cyanoaniine, 4-n-pentyl-4-cyanobiphenyl (5CB), and 4,4′-bipyridine, which are respectively represented by the following Structural Formulae (15) to (19): 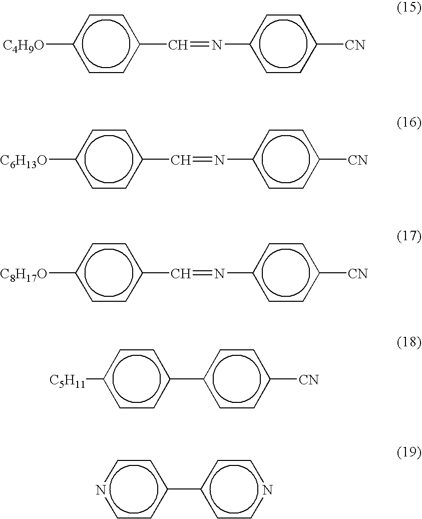
and a compound represented by the following Structural Formula (20): 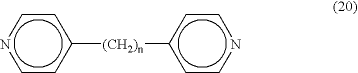
Note that in Structural Formula (20) n is a recurring unit which may be 0, or any integer from 1 to 9.

Furthermore, in the present embodiment, the following other liquid crystal compound or the like may be also used (but the present invention is not limited to them): 1,2-difluoro-4-[trans-4-(trans-4-ethylcyclohexyl) cyclohexyl]benzene, 1,2-difluoro-4-[trans-4-(trans-4-propylcyclohexyl) cyclohexyl]benzene, and 1,2-difluoro-4-[trans-4-(trans-4-pentylcyclohexyl) cyclohexyl]benzene, which are respectively represented by the following Structural Formulae (21) to (23).

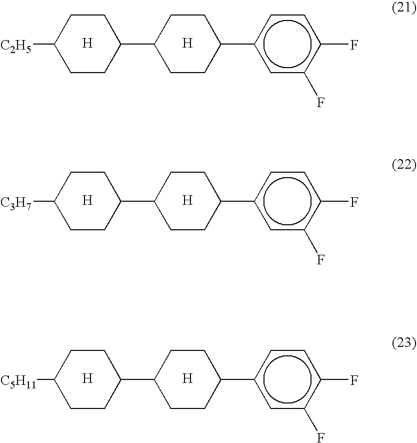

As to the liquid crystal compounds that may be used in combination with the liquid crystal compound having the ability of forming the intermolecular hydrogen bond, the liquid crystal compounds may be used solely, or two or more of the liquid crystal compounds may be used in combination in an appropriate manner.

The dielectric liquid 6 used in the present embodiment is not particularly limited in terms of its composition, provided that the dielectric liquid 6 contains the liquid crystal compound having the ability of forming the intermolecular hydrogen bond. Specific examples are: (a) a mixture of 4-n-hexyloxy benzoic acid represented by Formula (1), 4-(4-octyloxyphenylethynyl)pyridine represented by Formula (2), p-butoxybenzylidene-cyanoanilline represented by Formula (15), p-hexyloxybenzylidene-cyanoanilline represented by Formula (16), and p-octyloxybenzylidene-cyanoanilline represented by Formula (17); and (b) a mixture of p-cyanobenzal-p-amino benzoic acid represented by Formula (3), p-n-amyl benzoic acid represented by Formula (4), and 5CB represented by Formula (18).

Moreover, another example of appropriate materials as the dielectric liquid 6 of the present embodiment is a mixture of one of the liquid crystal compounds represented by Formulae (15) to (17), and at least one of the liquid crystal compounds, represented by Formulae (5) to (11), and their derivatives. Apart from those, still another examples of appropriate materials as the dielectric liquid 6 of the present embodiment are: a mixture of a phenol derivative represented by Formula (12) and/or Formula (13), and 4,4′-bipyridene represented by Formula (19); a mixture of a liquid crystal compound or a benzoic acid derivative, represented by Formula (14), and the liquid crystal compound represented by Formula (20); and the like. However, the present invention is not particularly limited to those.

In the present embodiment, the liquid crystal compound having the ability of forming the intermolecular hydrogen bond is not particularly limited in terms of an amount. The amount of the liquid crystal compound having the ability of forming the intermolecular hydrogen bond may be arbitrarily set according to its kind or the like. It may be arranged that the dielectric liquid 6 is a liquid crystal composition (mixture liquid crystal) that consists of only the liquid crystal compound having the ability of forming the intermolecular hydrogen bond. However, it is desirable that the liquid crystal compound having the ability of forming the intermolecular hydrogen bond be contained in the dielectric liquid 6, by 10% or more but by 70% or less by weight percent.

If the liquid crystal compound was contained by less than 10% by weight, there is a possibility that the clusters would not be sufficiently enlarged and thus the effect of the use of the liquid crystal compound having the ability of forming the intermolecular hydrogen bond would not be sufficient. On the other hand, if the liquid crystal compound was contained by more than 70% by weight, there is a possibility that the liquid crystal liquid 6 would have a smaller resistivity and thus voltage-holding characteristics of the cell 31 would be reduced.

It is preferable that, in the dielectric liquid 6, a sum of quantities of the liquid crystal compound having the ability of forming the intermolecular hydrogen bond, be 20% or higher, but 60% or lower by weight, because the temperature dependency of the Kerr constant B is significantly reduced but the voltage holding characteristic is not significantly lowered when the sum of the quantities is within this range.

The dielectric liquid 6 made of the liquid crystal material containing the liquid crystal compound having the ability of forming the intermolecular hydrogen bond has such clusters that have a large size and a long life because the intermolecular hydrogen bonds are formed in dielectric liquid 6. According to the present embodiment, it is possible to provide a display apparatus in which the Kerr effect has a lower temperature dependency.

The intermolecular hydrogen bond may be formed between molecules of the liquid crystal compound having the ability of forming the intermolecular hydrogen bond. However, it is needless to say that the intermolecular hydrogen bond may be formed between a molecule of the liquid crystal compound having the ability of forming the intermolecular hydrogen bond, and a molecule of a non liquid crystal compound having an ability of forming the intermolecular hydrogen bond with the liquid crystal compound having the ability of forming the intermolecular hydrogen bond, by arranging such that the dielectric liquid 6 contains the non liquid crystal compound having that ability of forming the intermolecular hydrogen bond with the liquid crystal compound having the ability of forming the intermolecular hydrogen bond.

The non liquid crystal compound having the ability of forming the intermolecular hydrogen bond is not particularly limited, provided that the non liquid crystal compound does not adversely affects the property of the dielectric liquid 6 and can cause the dielectric liquid 6 to be in the isotropic state in which the dielectric liquid 6 is transparent with respect to the visible light. Specifically, the non liquid crystal compound may be, but not limited to, alcohols such as ethanol and the like, phenols, thiophenols, and the like groups, for example.

In case where the dielectric liquid 6 contains the non liquid crystal compound having the ability of forming the intermolecular hydrogen bond, a ratio of the non liquid crystal compound in the dielectric liquid 6 is preferably 10% by weight or lower, and more preferably 3% by weight or lower. If the ratio of the non liquid crystal compound was more than 10% by weight, there is a possibility that the dielectric liquid 6 would not have an ability of forming the clusters.

Moreover, the present invention is not limited to the formation of intermolecular hydrogen bond, and a similar effect is obtained by attaining the enlargement of the size of the cluster by forming a complex.

Next, the following describes a display apparatus in which a dielectric liquid 6 containing a smectic liquid crystal compound having a smectic phase, that is, a smectic liquid crystal phase (Sm phase) is used. Note that the display apparatus has the same arrangement and display principle as described above. Therefore, the following mainly explains the dielectric liquid 6 for use in the display apparatus.

The smectic liquid crystal compound for use in the present embodiment is a liquid crystal compound having a layer structure having a translational periodicity which has not only an order in an alignment of longitudinal axes of molecules (the order the nematic phase has), but also an order in centers of gravity of the molecules. Specific examples of the smectic liquid crystal compound are: p-chlorobenzoic acid, 4-hexyloxyphenyl-4′-azopyrizine, 1-(4-n-pentylbiphenyl)-2-(4-trifluoromethoxyphenyl)ethane, 4′-2-methylbutyl-4-cyanobiphenyl, which are respectively represented by the following Structural Formulae (24) to (27), and the like compound. The smectic liquid crystal compound may have an ability of forming intermolecular hydrogen bond, for example, like p-chlorobenzoic acid represented by Structural Formula (24).

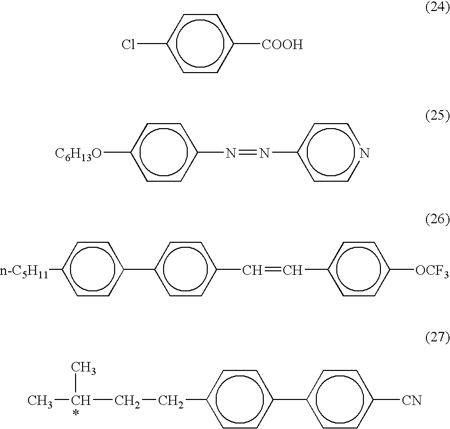

Moreover, apart from the liquid crystal compounds listed above, the smectic liquid crystal compound may be compounds respectively represented by the following Structural Formulae (28) to (41). However, the smectic liquid crystal compound is not particularly limited to these compounds. Note that in Structural Formulae (33) and (34), each of R¹² to R¹⁵ is independently an alkyl group having one to twelve carbon atoms, an alkyloxy group having one to twelve carbon atoms, or an alkyloxyalkyl group having one to twelve carbon atoms.

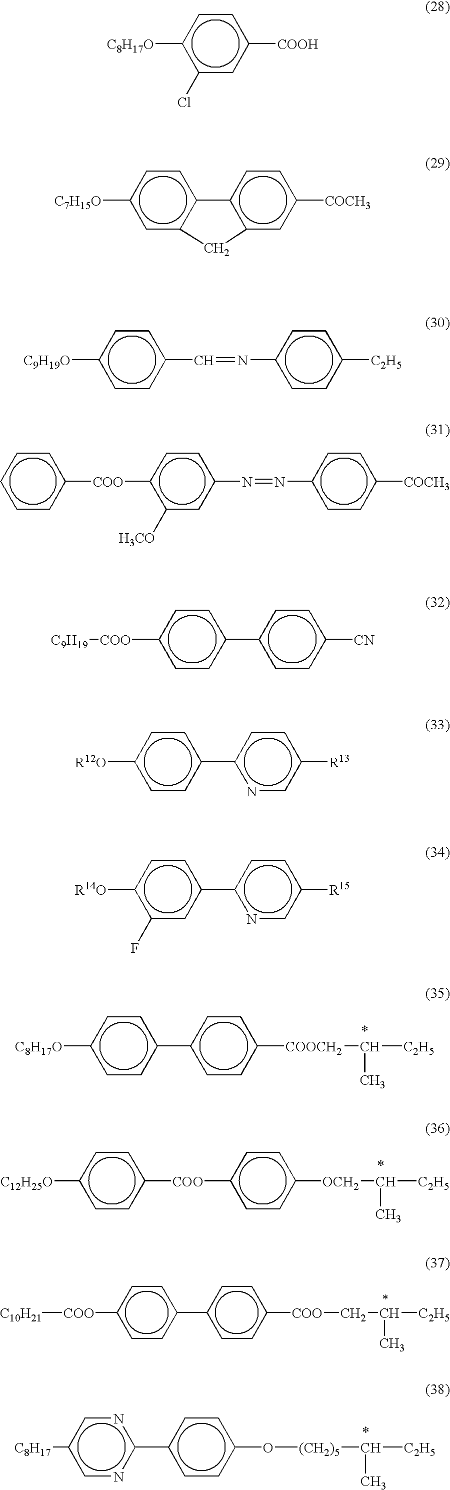

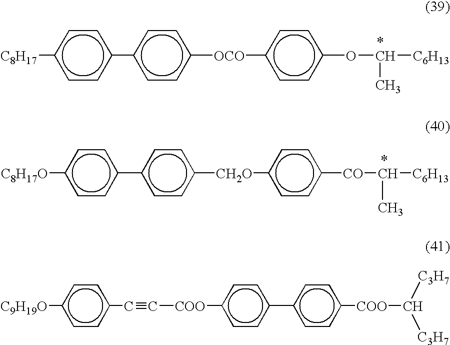

These smectic liquid crystal compounds may be used solely, or two or more of them may be used in combination appropriately. Of the smectic liquid crystal compounds, a liquid crystal compound having a cyano group as a terminal group is preferable, because such compound shows a larger dipole moment.

The dielectric liquid 6 may be a mixture of (a) the smectic liquid crystal compound and (b) at least one of at least one compound selected from the liquid crystal compounds represented by Structural Formulae (15) to (23) and the liquid crystal compound having the intermolecular hydrogen bond.

The smectic liquid crystal compound may have any phase, such as an SmA phase, an SmB phase, an SmC phase or the like phase. Further, the smectic liquid crystal compound may be a dextrorotary chiral liquid crystal, a levorotary material, or a smectic liquid crystal compound having no optical rotation.

The liquid crystal composition, which contains the smectic liquid crystal compound and is used as the dielectric liquid 6, is not particularly limited in terms of its composition, provided that the dielectric liquid 6 contains the smectic liquid crystal compound. Specific examples of the liquid crystal composition are as follows: (a) a mixture of p-chlorobenzoic acid represented by Formula (24), 4-hexyloxylphenyl-4′-azopyrizine represented by Formula (25), p-butoxybenzylidene-cyanoanilline represented by Formula (15), p-hexyloxybenzylidene-cyanoaniline represented by Formula (16), and p-octyloxybenzyliden-cyanoanilline represented by Formula (17); (b) a mixture of 1-(4-n-pentylbiphenyl)-2-(4-tryfluoromethoxyphenyl) ethane represented by Structural Formula (26), and at least one of the liquid compounds respectively represented by Formulae (15) to (17); a mixture of 4-2-methylbutyl-4-cyanobiphenyl represented by Formula (27), 1,2-difluoro-4-[trans-4-(trans-4-ethylcyclohexyl) cyclohexyl] benzene represented by Formula (21), 1,2-difluoro-4-[trans-4(trans-4-propylcyclohexyl)cyclohexyl] benzene represented by Formula (22), and 1,2,-difluoro-4-[trans-4-(trans-4-pentylcyclohexyl) cyclohexyl] benzene represented by Formula (23); and the like mixture.

Moreover, liquid crystal compositions in which the smectic liquid crystal compound represented by Formulae (28) to (41) are used instead of the smectic liquid crystal composition represented by Formulae (24) to (27), are appropriate examples as materials used as the dielectric liquid 6 according to the present embodiment. Note that C* in the formulae is an asymmetric carton atom, (a chiral center).

The smectic liquid crystal compound according to the present embodiment is not particularly limited and may be arbitrarily set in terms of an amount to use, according to the composition of the dielectric liquid 6, especially, types and the like property of the smectic liquid crystal compound. The dielectric liquid 6 may be a liquid crystal composition (mixture liquid crystal) that consists of only the smectic liquid compound/the smectic liquid compounds. However, it is desirable that a total amount (smectic liquid crystal compound content) of the smectic liquid crystal compound in the dielectric liquid 6 is, by weight, 10% or more, but 90% or less.

Smectic liquid crystal compound content of less than 10% by weight does not sufficiently enlarge the cluster size, whereby the effect of the use of the liquid crystal compound having an ability of forming the intermolecular hydrogen bonding would be possibly insufficient. On the other hand, smectic liquid crystal compound content of more than 90% by weight gives a small resistivity to the dielectric liquid 6, whereby the cell 31 would possibly have a low voltage holding property.

Total content of the smectic liquid crystal compound content in the dielectric liquid 6 preferably has a lower limit of 20% by weight, and an upper limit of 60% by weight, and more preferably has a lower limit of 30% by weight, and an upper limit of 40% by weight, because the smectic liquid crystal compound content within such ranges significantly reduces the temperature dependency of the Kerr constant B, thereby making it possible to attain a practical voltage holding property, and gives a wider temperature range within which the temperature variation of the Kerr constant B is kept within not more than ±30° C.

A Kerr-effect liquid crystal in which the dielectric liquid 6 contains the smectic liquid crystal compound has a large intermolecular interaction and thus reduces the temperature dependency of the Kerr constant B. Hence, the Kerr-effect liquid crystal is practically significant. According to the present embodiment, as described above, the use of the dielectric liquid 6 containing the smectic liquid crystal compound also provides a display apparatus in which the Kerr effect is less temperature dependent.

Next, a display apparatus in which a particulate is provided as the core of the cluster, is described below. Note that the display apparatus has the same arrangement and display principle as described above. Thus, the following mainly explains a dielectric liquid 6 used in the display apparatus.

The particulate used in the present embodiment is, as described above, used as the core of the cluster. Because it is necessary that the dielectric liquid 6 containing the particulate be transparent with respect to the visible light at the usage environment temperature, the particulate is particles smaller than a wavelength of light and transparent to the visible light, specifically, particles of 0.1 μm or less in diameter.

Scattering of light is ignorable when the particulate has a diameter of 0.1 μm or less, that is, when the diameter of the particles of the particulate is smaller than the wavelength of the incident light. Therefore, the particulate is transparent with respect to the visible light, as long as the particulate is 0.1 μm or less in diameter.

In the present embodiment, for example, a particulate called nano particulate is used is used as the particulate satisfying the above requirements. The particulate has a diameter of 80 nm or less preferably, and a diameter of 50 nm or less more preferably, in order that the cluster whose core is the particulate may have a diameter (to be more exact, a length of a cluster longitudinal axis) smaller than the wavelength of light, so as to obtain a dielectric liquid 6 transparent to the visible light at the usage environment temperature. As described above, the scattering is ignorable when the diameter of the particulate is smaller than the wavelength of light.

The particulate may be any particle that is, for example, 0.1 μm or less in diameter as described above and allows the liquid crystal molecules to attach on its surface physically or chemically. Specific examples of the particulate are inorganic compounds such as palladium, silicon dioxide, magnesium dioxide, aluminum oxide, titan dioxides and the like; organic compounds such as polystyrene, polymethylmethacrylate, polyethylenetelephtalate, polychiofine, and the like, and particles prepared by subjecting these compounds to surface treatment; and the like particulates. These particulates may be used solely, or two or more of them may be used in combination.

Of these particulates, preferably used are the particulate having palladium (Pd) on its surface, especially, a nano particulate (Pd nano particulate) made from Pd, and a nano particulate that is constituted by supporting Pd by using a carrier. Among those preferable particles, the Pd nano particulate is more preferable. Because the Pd nano particulate has Pd on its surface, it becomes easier for the liquid crystal molecules to be adsorbed physically or chemically on the surface of the Pd nano particulate, thereby making it possible to form a cluster having a long life even if the temperature rises.

It may be arranged that the particulate is dispersed in the dielectric liquid 6, or that the particulate is dispersed in at least one of the dielectric thin films 26 and 27, which touch the dielectric liquid layer 41 made of the dielectric liquid 6, for example, in the dielectric thin film 26 that is the organic thin film provided on the surface of the comb-like shaped electrodes 24 and 25 provided on the pixel substrate 32.

In the arrangement in which the particulate is dispersed in the dielectric liquid 6, the particulate is added and mixed into the liquid crystal compound (liquid crystal composition). Moreover, in the arrangement in which the particulate is dispersed into the at least one of the dielectric thin films 26 and 27, the particulate may be added and mixed into a raw material of the dielectric thin film 26 and/or 27 before forming the dielectric thin film 26 and/or 27, or may be added on the at least one of the dielectric thin films 26 and 27 before curing the dielectric thin film 26 and/or 27.

The above-mentioned various liquid crystal compound (liquid crystal composition) may be adopted as the liquid crystal compound (liquid crystal composition) used in the arrangement in which the particulate is dispersed in the dielectric liquid 6, that is, as another composition (component) of the dielectric liquid 6 than the particulate.

Similarly, the above-mentioned various liquid crystal compound (liquid crystal composition) may be adopted for use in the dielectric liquid 6 in the arrangement in which the particulate is dispersed into the at least one of the dielectric thin films 26 and 27.

With the arrangement in which the particulate is dispersed into the at least one of the dielectric liquid layer 6 and the dielectric thin films 26 and 27, it becomes easier for the liquid crystal molecules to be adsorbed physically or chemically on the surface of the particulate, thereby making it possible to form a cluster having a long life. Therefore, it is possible to provide a display apparatus in which the temperature dependency of the Kerr effect is reduced.

Note that the display apparatus is not particularly limited in terms of the liquid crystal compound (liquid crystal composition) used in the dielectric liquid 6, and any one (or some) of the liquid crystal compounds (liquid crystal composition) may be appropriately selected as the liquid crystal compound used in the dielectric liquid 6. The liquid crystal composition, that is, the dielectric liquid 6 preferably contains the liquid crystal compound having a cyano group as its terminal group. With the arrangement in which the liquid crystal compound contained in the dielectric liquid 6 has a cyano group as a terminal group thereof, it is easy to form the cluster because the nitrogen atom in the cyano group easily faces toward the particulates. Hence, a cluster having a larger size and longer life will be formed.

For example, in case where the dielectric liquid 6 contains 5CB, the cluster is formed in such a manner that 5CB is so orientated (aligned) that cyano group faces toward Pd. This cluster is stable in a wide temperature range above the transparent point of 5CB, and thus is quite effective for reducing the temperature dependency of the Kerr effect.

In the display apparatus, the Kerr effect tends to be larger as the particulate is contained in a larger ratio (content ratio of the particulate is larger) in the dielectric liquid 6/the at least one of the dielectric thin films 26 and 27 until a certain content ratio. If the particulate is contained more than the certain ratio, the Kerr effect will be saturated due to dispersibility of the particulate in the dielectric liquid 6.

In the former arrangement, that is, in the arrangement in which the particulate is added in the dielectric liquid 6, the Kerr effect will be saturated when the particulate is contained in the dielectric liquid 6 by more than 10% by weight. On the other hand, the latter arrangement, that is, in the arrangement in which the at least one of the dielectric thin films 26 and 27 contains the particulate, the Kerr effect will be saturated when the particulate is contained in the dielectric liquid 6 by more than 20% by weight.

For this reason, in practice, the content ratio in the former arrangement is preferably 3% by weight or more but 10% by weight or less, and is more preferably 5% by weight or more but 10% by weight or less. Whereas in practice, the content ratio in the latter arrangement is preferably 3% by weight or more but 20% by weight or less, and is more preferably 5% by weight or more but 20% by weight or less.

As described above, each display apparatus according to the present embodiments is, arranged as follows: the display apparatus, which includes (a) a pair of substrates (ie. pixel substrate 32 and counter substrate 33) at least one of which is transparent, (b) a dielectric liquid layer 41 containing a liquid crystal compound whose refractive index is changed by an electric field applied thereon; and (c) an electrode or the like (eg. comb-like shaped electrodes 24 and 25) for applying the electric field onto the dielectric liquid layer 41, the display apparatus performing display operation by using a secondary electro-optical effect in which the refractive index is in proportion with square of the electric field, is so arranged that the dielectric liquid layer 41 contains clusters at a temperature that is equal to or higher than a liquid crystal-isotropic phase transition temperature of the liquid crystal compound, and is transparent to visible light, the clusters formed by locally aligning liquid crystal molecules in the liquid crystal compound at the temperature that is equal to or higher than the liquid crystal-isotropic phase transition temperature of the liquid crystal compound. If the clusters contain at least one of, for example, (i) a liquid crystal compound in which the intermolecular hydrogen bond is formed, (ii) a smectic liquid crystal material, and (iii) a particulate, the clusters have a larger cluster size than those in an ordinary liquid crystal material, that is, in a liquid material in which clusters have one of those (i) to (iii), whereby the clusters remain in the dielectric liquid layer 41 even at a temperature at or above the liquid crystal-isotropic phase transition temperature of the liquid crystal compound. The presence of the clusters even at a temperature at or above the liquid crystal-isotropic phase transition temperature of the liquid crystal compound alleviates the reduction of the Kerr effect at the temperature.

Because of this, according to the present embodiment, it is possible to provide a display apparatus in which (a) the clusters have a long life even if the temperature rises, (b) the Kerr effect has a small temperature dependency, and (c) display operation is carried out with a wide viewing angle and a high speed response. The following is a deduced reason why in the dielectric liquid layer 41 the Kerr constant B has a small temperature dependency: The liquid crystal compound itself is a liquid having a short distance order as described above. As the temperature rises, a degree of alignment order of the liquid crystal compound decreases. However, as described above, the clusters of a large cluster size can be obtained by causing the liquid crystal compound (from which the dielectric liquid layer 41 is made) to have a higher intermolecular interaction. The large cluster size gives the clusters a longer life even if the temperature rises, thus reducing the temperature dependency of the Kerr constant B.

The small temperature dependency of the Kerr effect indicates that the driving voltage is less temperature-dependent (that is, the display property is less temperature dependent). This is practically significant.

As described above, the temperature dependency of the Kerr constant of the dielectric liquid layer 41 relates to the temperature dependency of the driving voltage. If voltage variation is about ±15%, it is possible to structure a practical display apparatus by using a circuit for compensating for the temperature variation, or a circuit for monitoring the electric property of a pixel and feeding back a result of the monitoring to the value of the driving voltage. The ±15% variation in the driving voltage is equivalent to ±30% variation in the magnitude of the Kerr constant B. In the present invention, it is arranged, as described above, that the dielectric liquid layer 41 contains the clusters even at a temperature at or above the liquid crystal-isotropic phase transition temperature of the liquid crystal compound. Thus, according to the present invention, it is possible to keep the variation of the Kerr constant with in not more than ±30%, when the dielectric liquid is at a temperature in a range of from (a) the secondary phase transition temperature with respect to the liquid crystal-isotropic phase transition temperature, to (b) the temperature 5° C. higher than the secondary phase transition temperature.

Moreover, according to the present invention, it is unnecessary to apply a higher voltage to carry out the display operation, because the Kerr effect B is not reduced. Thus, it is possible to drive the display apparatus with a low voltage.

It is possible to reduce the temperature dependency of the Kerr effect, and there is no need of having, in order to reduce the temperature dependency of the Kerr effect, another conventional arrangement that complicates production of the display apparatus, for example, the arrangement in which the region of the liquid material is divided into sub-regions. Thus, this arrangement provides a display apparatus that can be easily produced and has a high reliability.

The following specifically descries the temperature dependency of the Kerr effect in the display apparatus according to the present embodiment, referring to Examples and Comparative Example. It should be noted that the present invention is not limited to those Examples.

[Production of Cell (A)]

Each Cell (A) used in the following Examples 1 to 7, and Comparative Example 1 were produced as follows. Firstly, a layer of aluminum was formed in a thickness of 0.2 μm on a surface of a substrate 23 made of glass, the aluminum serving as an electrode material. Then, the layer of aluminum was subjected to patterning, thereby forming comb-like shaped electrodes 24 and 25 having a line width of 10 μm and electrode intervals of 10 μm as shown in FIGS. 2 and 3. Next, on the surface of the substrate 23, a polyimide film (alignment film “SE-7792 (product name)” made by Nissan Chemical Industries Ltd.) was produced as a dielectric thin film 26. Then, rubbing treatment was conducted to rub the a surface of the dielectric thin film 26 along “comb-teethes” of the comb-like shaped electrodes 24 and 25 in the direction of Arrow J. Hereby, a pixel substrate 32 was formed.

On a surface of a substrate 28 made of glass, a polyimide film of a similar kind to the dielectric thin film 26 was formed as the dielectric thin film 27. Then, rubbing treatment was conducted to rub the a surface of the dielectric thin film 27 along “comb-teethes” of the comb-like shaped electrodes 24 and 25 in the direction (of Arrow K) opposite to Arrow J. Hereby, a counter substrate 33 was formed.

After that, the pixel substrate 32 and the counter substrate 33 were bounded together with a glass fiber space therebetween by using a sealing agent 34 in such a manner that there was a gap A of 10 μm between the substrates. Into the gap A, a liquid material (liquid crystal composition) as a dielectric liquid 6 was introduced. Polarizers 22 and 29 were provided so as to sandwich the pixel substrate and the counter substrate 33 therebetween as shown in FIG. 1, in such a manner that absorption axes of the polarizers 22 and 29 crossed each other at the right angle, and made 45 degrees with the directions of Arrows J and K respectively. Hereby, the cell (A) as a cell 31 was produced.

Note that, for measuring a Kerr constant B, it is important to control a temperature of the cell 31. In the following Examples and Comparative Example, therefore the Kerr constant B was measured while the cell (A) as the cell 31 was kept in an electronic cooling apparatus (custom-made by JEOL, Ltd.) so as to carry out temperature control (PID; Proportional Integral Differential Control) of the cell (A). A half-wave length Vπ of when I=I₀ was measured while the temperature of the cell (A) was changed. Then, the Kerr constant B was calculated out from Equation (6) by using the half-wave length Vπ thus measured. The temperature control was performed with accuracy of ±0.05° C. at temperatures ranging from −20° C. to 40° C., and of ±0.1° C. at temperatures ranging from 40° C. to 150° C.

Moreover, 4-n-hexyloxybenzoic acid represented by Formula (1) and 4-(4-octyloxyphenyethynyl)pyridine represented by Formula (2) were synthesized by the method that was adopted by Xiangzhi Song (Liquid crystals, 2002, Vol.29, No. 12, pp.1533-1537). For the other compounds, commercially available compounds were used.

### EXAMPLE 1

Prepared was a mixture containing (i) 20.7 parts by weight of 4-n-hexyloxybenzoic acid represented by Formula (1), (ii) 29.3 parts by weight of 4-(4-octyloxyphenylethynyl)pyridine represented by Formula (2), and (iii) 50 parts by weight of an equal-amount mixture (hereinafter, an equal-amount mixture (I)) containing, in equal amounts, p-butoxybenzylidene-cyanoanilline represented by Formula (15), p-hexyloxybenzylidene-cyanoaniline represented by Formula (16), and p-octyloxybenzyliden-cyanoanilline represented by Formula (17). The thus prepared mixture was heated by using a heater thereby obtaining a transparent liquid crystal material (liquid crystal composition), which served as the dielectric liquid 6 of the present embodiment. By using the liquid crystal material, a Kerr constant B was measured in the aforementioned method while a temperature of a cell (A) was changed. A result of the measurement is shown in FIG. 7. In FIG. 7, the horizontal axis for Example 1 indicates differences between temperatures T at measurement and the secondary transition temperature T* (=106.3° C.).

### COMPARATIVE EXAMPLE 1

In Comparative Example 1, a temperature dependency of a Kerr constant B was measured in the same fashion as in Example 1, except that no liquid crystal compound having an ability of forming the intermolecular hydrogen bond was used in Comparative Example 1. Specifically, a transparent liquid crystal material (liquid crystal composition) was obtained by preparing an equal-amount mixture (I) and then heating the equal-amount mixture (I) by using a heater, the equal-amount mixture (I) containing, in equal amounts, p-butoxybenzylidene-cyanoanilline represented by Formula (15), p-hexyloxybenzylidene-cyanoaniline represented by Formula (16), and p-octyloxybenzyliden-cyanoanilline represented by Formula (17). By using the liquid crystal material, the Kerr constant B was measured, in the same fashion as in Example 1, while a temperature of a cell (A) was changed. A result of the measurement is shown in FIG. 7 together with the result of Example 1. Note that in FIG. 7 the horizontal axis for Comparative Example indicates differences between temperatures T at measurement and the secondary transition temperature T* (=95.7° C.).

As seen from FIG. 7, the dielectric liquid 6 for use in the display apparatus according to the present embodiment had a smaller temperature dependency of the Kerr constant B, compared with the liquid crystal material that contained no liquid crystal compound having the ability of forming the intermolecular hydrogen bond. This indicates that a temperature dependency of a driving voltage is low (that is, a temperature dependency of a display property is low) in the dielectric liquid 6 for use in the display apparatus according to the present embodiment. This feature of the dielectric liquid 6 for use in the display apparatus according to the present embodiment is practically significant.

The following was deduced as the reasons why the Kerr constant B has a low temperature dependency in the dielectric liquid 6 for use in the display apparatus according to the present embodiment: The liquid crystal compound having the ability of forming the intermolecular hydrogen bond as the liquid crystal compound in Example 1 has a strong intermolecular interaction. Therefore, with the liquid crystal compound having the ability of forming the intermolecular hydrogen bond, it is possible to form a cluster having a larger cluster size than in the arrangement in which no liquid crystal compound having the ability of forming the intermolecular hydrogen bond is used. It was deduced that the larger cluster size gave the cluster a longer life even if the temperature is increased. It was deduced that this results in the smaller temperature dependency of the Kerr constant B.

It should be noted that in Example 1 the liquid crystal compound having a hydroxyl group was used as the liquid crystal compound having the ability of forming the intermolecular hydrogen bond. However, the present invention is not limited to this. Moreover, a similar effect is expected in an arrangement in which a larger cluster size is attained by forming a complex, instead of by using the hydrogen bonding.

### EXAMPLE 2

A mixture was prepared by mixing, with the equal-amount mixture (I), an equimolar mixture (hereinafter, an equimolar mixture (II)) prepared by mixing 4-n-hexyloxybenzoic acid represented by Formula (1) and 4-(4-octyloxyphenylethynyl)pyridine represented by Formula (2). Temperature dependency of a Kerr constant B of the mixture was measured in the same fashion as in Example 1. Table 1 shows a relationship between a value of the Kerr constant B and content ratios of the equimolar mixture (II) in the liquid crystal composition, where the Kerr constant B was measured when a difference between a temperature T at measurement and a secondary transition temperature T* was 2° C., and the content ratio of the equimolar mixture (II) in the liquid crystal composition was a constant ratio of the liquid crystal compound having an ability of forming the intermolecular hydrogen bond in the liquid crystal composition constituted by these liquid crystal compounds.

TABLE 1

| Content Ratio | |
|---|---|
| of Equimolar | Kerr |
| Mixture (II) | Constant B |
| (% by weight) | (cm/V²) |
| 0 | 461 × 10⁻¹⁰ |
| 10 | 622 × 10⁻¹⁰ |
| 20 | 835 × 10⁻¹⁰ |
| 30 | 878 × 10⁻¹⁰ |
| 50 | 950 × 10⁻¹⁰ |
| 60 | 850 × 10⁻¹⁰ |
| 70 | 770 × 10⁻¹⁰ |
| 80 | 444 × 10⁻¹⁰ |
| 100 | 307 × 10⁻¹⁰ |

Table 1 shows that the Kerr constant B was large when the content ratio of the equimolar mixture (II) was 10% by weight or more but 70% by weight or less. This indicates that a cluster size was larger when the content ratio of the equimolar mixture (II) was 10% by weight or more but 70% by weight or less, than when only the equal-amount mixture (I) was used. Thus, the Kerr constant was larger when the content ratio of the equimolar mixture (II) was 10% by weight or more but 70% by weight or less, than when only the equal-amount mixture (I) was used. If the content ratio of the equimolar mixture (II) was less than 10% by weight, the cluster size would not be sufficiently enlarged. If the content ratio of the equimolar mixture (II) was more than 70% by weight, the dielectric liquid 6 would have a low electric resistivity, thereby lowering voltage-holding property of the cell (A) (display element). Therefore, it is not preferable that the content ratio of the equimolar mixture (II) is less than 10% by weight, or more than 70% by weight.

### EXAMPLE 3

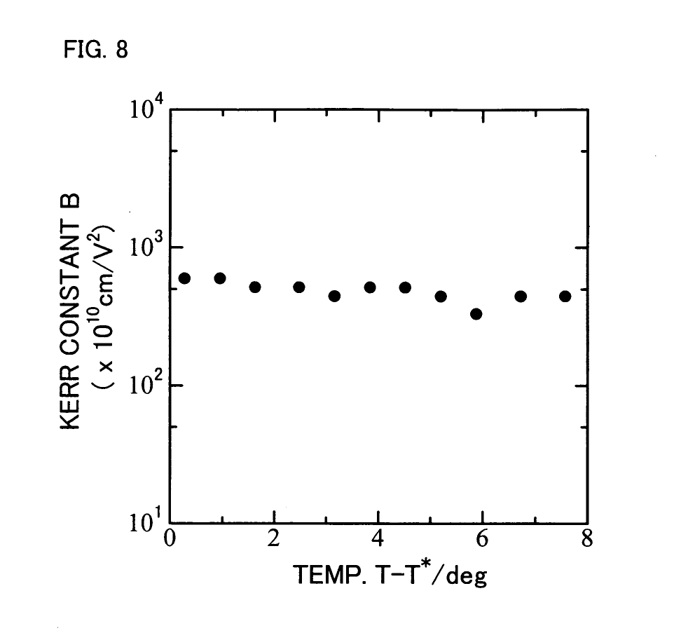

A Kerr constant B was measured in the same fashion as in Example 1, except that a mixture (liquid crystal composition) was used as a dielectric liquid 6 according to the present embodiment, the mixture containing 20 parts by weight of p-cyanobenzal-p-amino benzoic acid represented by Formula (3), 20 parts by weight of p-n-amyl benzoic acid represented by Formula (4), and 60 parts by weight of 4-n-benzyl-4-cyanobiphenyl (5CB) represented by Formula (18). A result of the measurement is shown in FIG. 8. In FIG. 8, the horizontal axis indicates differences between temperatures T at measurement and the secondary transition temperature T* (=109.7° C.).

In the present Example, it was deduced that the cluster size in the dielectric liquid 6 was large because of intermolecular hydrogen bond formation in the dielectric liquid 6, the dielectric liquid 6 containing p-cyanobenzal-p-amino benzoic acid represented by Formula (3), and p-n-amyl benzoic acid represented by Formula (4), and the large cluster size reduced the temperature dependency of the Kerr constant B.

### EXAMPLE 4

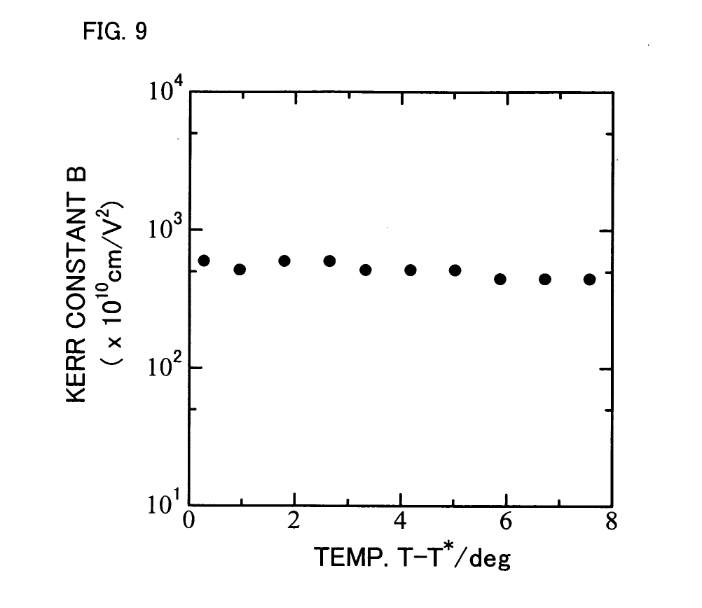

A Kerr constant B was measured in the same fashion as in Example 1, except that a mixture (liquid crystal composition) was used as a dielectric liquid 6 according to the present embodiment, the mixture containing 17.8 parts by weight of p-chlorobenzoic acid represented by Formula (24), 32.2 parts by weight of 4-hexyloxyphenyl-4′-azopyrizine represented by Formula (25), and 50 parts by weight of the equal-amount mixture (I). A result of the measurement is shown in FIG. 9. In FIG. 9, the horizontal axis indicates differences between temperatures T at measurement and the secondary transition temperature T* (=108.8° C.).

In the present embodiment, a smectic liquid crystal phase and a strong intermolecular interaction were obtained by p-chlorobenzoic acid represented by Formula (24) and 4-hexyloxyphenyl-4′-azopyrizine represented by Formula (25). Thus, it was deduced that the formation of the smectic liquid crystal phase and the strong intermolecular interaction gave the dielectric liquid 6 containing the smectic liquid crystal compound a large cluster size that resulted in low temperature dependency of the Kerr constant B.

### EXAMPLE 5

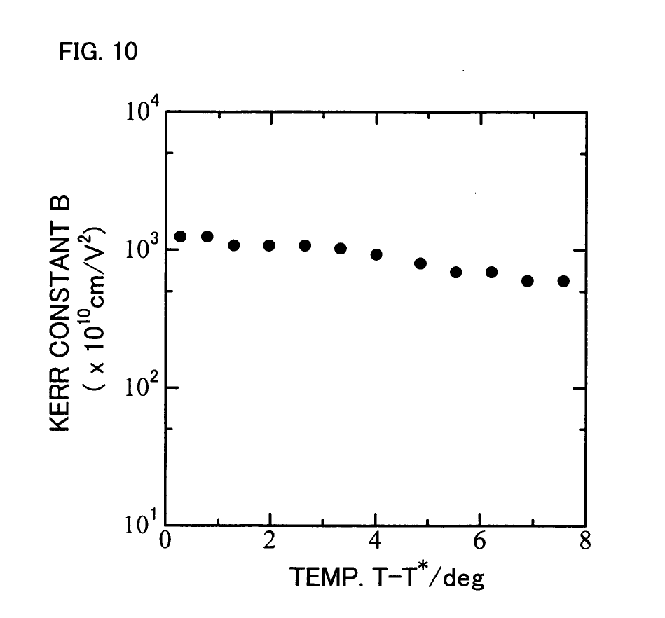

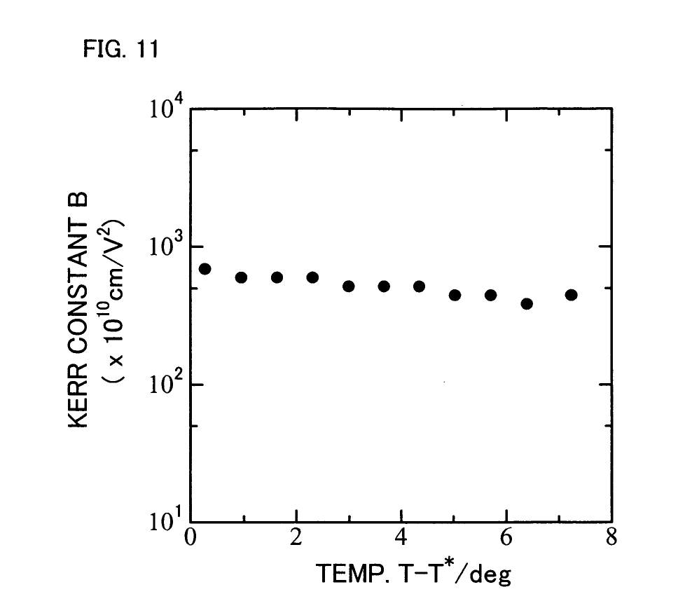

A Kerr constant B was measured in the same fashion as in Example 1, except that a mixture (liquid crystal composition) was used as a dielectric liquid 6 according to the present embodiment, the mixture containing 40 parts by weight of 1-(4-n-pentylbiphenyl)-2-(4-trifluoromethoxyphenyl)ethane represented by Formula (26) and 60 parts by weight of the equal-amount mixture (I). A result of the measurement is shown in FIG. 10. In FIG. 10, the horizontal axis indicates differences between temperatures T at measurement and the secondary transition temperature T* (=110.0° C.).

As shown by Examples 4 and 5, a Kerr-effect liquid crystal in which the dielectric liquid 6 contains the smectic liquid crystal compound has a large intermolecular interaction and thus reduces the temperature dependency of the Kerr constant B. Hence, the Kerr-effect liquid crystal is practically significant.

### EXAMPLE 6

Temperature dependency of a Kerr constant B of a mixture was measured in the same fashion as in Example 1, the mixture containing 4′-2-methylbutyl-4-cyanobiphenyl represented by Formula (27) and an equal-amount mixture (hereinafter, an equal amount mixture (III) containing, 1,2-difluoro-4-[trans-4-(trans-4-ethylcyclohexyl)cyclohexyl]benzene represented by Formula (21), 1,2-difluoro-4-[trans-4-(trans-4-propylcyclohexyl)cyclohexyl]benzene represented by Formula (22), and 1,2-difluoro-4-[trans-4-(trans-4-pentylcyclohexyl) cyclohexyl]benzene represented by Formula (23). Table 2 shows a relationship between a value of the Kerr constant B and content ratios of the smectic liquid crystal compound in the liquid crystal composition, that is, content ratios of 4′-2-methylbutyl-4-cyanobiphenyl represented by Formula (27) in the liquid crystal composition, where the Kerr constant B was measured when a difference between a temperature T at measurement and a secondary transition temperature T* was 2° C.

TABLE 2

| Content Ratio of | Kerr | Temp. |
|---|---|---|
| Smectic LCC | Constant B | Range |
| (% by weight) | (cm/V²) | TR (° C.) |
| 0 | 303 × 10⁻¹⁰ | 0.1 |
| 10 | 420 × 10⁻¹⁰ | 10.1 |
| 20 | 713 × 10⁻¹⁰ | 25.7 |
| 30 | 810 × 10⁻¹⁰ | 48 |
| 40 | 900 × 10⁻¹⁰ | 40.9 |
| 50 | 850 × 10⁻¹⁰ | 31.4 |
| 60 | 803 × 10⁻¹⁰ | 22.2 |
| 70 | 791 × 10⁻¹⁰ | 8.7 |
| 80 | 734 × 10⁻¹⁰ | 3.8 |
| 90 | 710 × 10⁻¹⁰ | 1.7 |
| 100 | 699 × 10⁻¹⁰ | 0.2 |

Abbreviation: LCC: Liquid crystal Compound
Temp.: Temperature
Note:
Temperate range TR is a temperature range within which the temperature variation of the Kerr constant B is in a range of less than 30%.

Table 2 shows that the Kerr constant B was large when the content ratio of the smectic liquid crystal compound represented by Formula (27) was 10% by weight or more but 90% by weight or less. This indicates that a cluster size was larger when the content ratio of the smectic liquid crystal compound was 10% by weight or more but 90% by weight or less, than when only the equal-amount mixture (III) was used. Thus, the Kerr constant was larger when the content ratio of the smectic liquid crystal compound was 10% by weight or more but 90% by weight or less, than when only the equal-amount mixture (III) was used.

Moreover, Table 2 also shows actual measurement values of TR (° C.), which is degree of temperature dependency of the Kerr effect when the smectic liquid crystal compound was in the isotropic phase. The degree of the temperature dependency is a temperature range within which the Kerr constant B varies within a range of less than ±30% after temperature change. According to Table 2, the temperature range was significantly wide when the content ratio of the smectic liquid crystal compound is 10% by weight or more but 60% by weight or less. Thus, the effect of reducing the temperature dependency of the Kerr effect is large when the content ratio of the smectic liquid crystal compound is 10% by weight or more but 60% by weight or less. As clearly seen from the result, the display apparatus according to the present invention has a largely-reduced temperature dependency of Kerr constant B, and thus is practically quite significant.

Note that in the present Example, the smectic liquid crystal compound used was a dextrorotary chiral liquid crystal. However, needless to say, a revorotary material or a smectic liquid crystal compound having no optical rotation. might be adopted in the present Example.

### EXAMPLE 7

Samples of mixtures (liquid crystal compositions) of 5CB and 5CB-Pd nano particulates were prepared. The 5CB-Pd nano particulate was prepared, by a standard method known in the art, by radiating ultraviolet light to an ethanol solution containing 10% by weight of a mixture of palladium acetate and 5CB (represented by Formula (18)) by 1:10 in mole so as to reduce 5CB to form 5CB-Pb, obtaining a mixture of 5CB and 5CB-Pd nano particulate. A Kerr constant B of each sample was measured at a temperature 5° C. higher than the secondary transition temperature T*. Results are shown in Table 3.

TABLE 3

| Content Ratio of | | |
|---|---|---|
| 5CB-Pd nano | | Kerr |
| Particulate | Ratio of 5CB | Constant B |
| (% by weight) | (% by weight) | (cm/V²) |
| 1 | 99 | 153 × 10⁻¹⁰ |
| 3 | 97 | 277 × 10⁻¹⁰ |
| 5 | 95 | 440 × 10⁻¹⁰ |
| 10 | 90 | 588 × 10⁻¹⁰ |
| 20 | 80 | 534 × 10⁻¹⁰ |
| 30 | 70 | 551 × 10⁻¹⁰ |

Table 3 shows that the larger content ratio of 5CB-Pd nano particulate gives a larger Kerr effect. Moreover, Table 3 shows that the Kerr effect will not become larger further when the content ratio of the particulate (5CB-Pd nano particulate) exceeds 10% by weight.

Further, a mixture of 5% 5CB-Pd nano particulate and 95% 5CB by weight was measured in terms of temperature dependency of a Kerr constant B in the same manner as in Example 1. A result of the measurement is shown in FIG. 11. In FIG. 11, the horizontal axis indicates differences between temperatures T at measurement and the secondary transition temperature T* (=32.4° C.).

In the present Example, clusters were so formed that 5Cb was so orientated that cyano group faces toward Pd. The clusters were stable within a wider temperature ranges higher than the transparent point of 5CB. Such clusters are quite effective for reducing the temperature dependency of Kerr constant.

Note that the present invention is not limited to the use of 5CB as the liquid crystal molecule to be oriented toward Pd, even though 5CB was used in the present Example.

### EXAMPLE 8

Firstly, a layer of ITO was formed in a thickness of 0.2 μm on a surface of a substrate 23 made of glass, the ITO serving as an electrode material. Then, the layer of ITO was subjected to patterning, thereby forming comb-like shaped electrodes 24 and 25 having a line width of 10 μm and electrode intervals of 10 μm as shown in FIGS. 2 and 3. Next, on the surface of the substrate 23, a polyimide film (alignment film “SE-7792 (product name)” made by Nissan Chemical Industries Ltd.) was produced as a dielectric thin film 26. Then, rubbing treatment was conducted to rub the a surface of the dielectric thin film 26 along “comb-teethes” of the comb-like shaped electrodes 24 and 25 in the direction of Arrow J. Hereby, a pixel substrate 32 was formed.

On a surface of a substrate 28 made of glass, a polyimide film of a similar kind to the dielectric thin film 26 was formed as the dielectric thin film 27. Then, rubbing treatment was conducted to rub the a surface of the dielectric thin film 27 along “comb-teethes” of the comb-like shaped electrodes 24 and 25 in the direction (of Arrow K) opposite to Arrow J. Hereby, a counter substrate 33 was formed.

After that, the pixel substrate 32 and the counter substrate 33 were bounded together with a glass fiber space therebetween by using a sealing agent 34 in such a manner that there was a gap A of 10 μm between the substrates. Into the gap A, the equimolar mixture (II) was introduced and sealed therein. Polarizers 22 and 29 were provided so as to sandwich the pixel substrate and the counter substrate 33 therebetween as shown in FIG. 1, in such a manner that absorption axes of the polarizers 22 and 29 crossed each other at the right angle, and made 45 degrees with the directions of Arrows J and K respectively. Hereby, a cell (A) as a cell 31 according to the present invention was produced.

A Half-wave voltage Vπ was measured while changing ambient temperature of the display apparatus. The half-wave voltage Vπ was 36.0V at 95.0° C., 36.4V at 101.3° C., and 37.1V at 107.2° C.

In the present Example, Pd particulate was dispersed in the dielectric thin films (alignment films) 26 and 27. Cyano group in Schiff base type liquid crystal was oriented toward the Pd particulates. Hence, large clusters were obtained thereby reducing a change of the half-wave voltage Vπ against temperature change.

In the present Example, the polyimide thin films were used as the dielectric thin films 26 and 27. However, the present invention is not limited to this. Moreover, in the present Example, the dielectric thin films 26 and 27 were provided on the electrodes. However, the present invention is not limited to this. By subjecting, to the rubbing treatment, the dielectric liquid layer 41 made from the dielectric liquid 6 so as to align the dielectric liquid layer 41, a plurality of liquid molecules behave as clusters in the vicinities of the substrates even at a time at which the dielectric liquid layer 41, in principle, becomes isotropic and thus the liquid crystal molecules are oriented randomly. (here, macroscopically, the dielectric liquid layer 41 is isotropic). Thus, it is possible to attain a large Kerr constant apparently.

### EXAMPLE 9

Cells (C), (D), (E), (F) and (G) were prepared by respectively by using the liquid crystal compositions prepared in Examples 1, 3, 4, 5, and 7, and following the conditions shown in Table 4. As in Example 8, a half-wave voltage Vπ of each of the cells (C), (D), (E), (F) and (G) was measured at a temperature in a range of from (a) the secondary phase transition temperature (T*) with respect to the liquid crystal-isotropic phase transition temperature, to (b) the temperature 5° C. higher than the secondary phase transition temperature (T*). Results are shown in Table 4, in which parameters in the designs of the cells are shown together.

TABLE 4

| | | | | | Half-wave |
|---|---|---|---|---|---|
| | Composition | Content Ratio | Cell Gap d | Interelectrode | Length Voltage |
| Cell | of Dielectric liquid | (% by weight) | (μm) | Gap L (μm) | Vπ (V) |
| (C) | LCC rep. by Formula (1) | 20.7 | 10 | 10 | 22.9 |
| | LCC rep. by Formula (2) | 29.3 | | | |
| | Equal-Amount Mixture (I) | 50 | | | |
| (D) | LCC rep. by Formula (3) | 20 | 5 | 10 | 29.1 |
| | LCC rep. by Formula (4) | 20 | | | |
| | LCC rep. by Formula (18) | 60 | | | |
| (E) | LCC rep. by Formula (24) | 17.8 | 7 | 5 | 13.1 |
| | LCC rep. by Formula (25) | 32.2 | | | |
| | Equal-Amount Mixture (I) | 50 | | | |
| (F) | LCC rep. by Formula (26) | 40 | 7 | 7 | 15 |
| | Equal-Amount Mixture (I) | 60 | | | |
| (G) | 5CB-Pd Nano Particulate | 5 | 3 | 5 | 14 |
| | LCC rep. by Formula (18) | 95 | | | |

Note that in Table 4 “LCC” is an abbreviation for “Liquid crystal Compound”, and “rep.” is an abbreviation for “represented”. As shown in Table 4, the display apparatus according to the present embodiment is drivable with a voltage of practical use, and thus is practically significant. The actual measurement values were larger than the half-wave voltage Vπ expected from the large value of the Kerr constant B by using Equation (5). It is deduced that the actual measurement values were larger because the comb-like shaped electrodes 24 and 25 did not give the cells electric field effects in a thickness direction thereof, and a direction of electric fields E was not orthogonal to a traveling direction of light.

Even though the polyimide thin films were used as the dielectric thin films 26 and 27 again in the present Example, the present invention is not limited to the polyimide thin films.

As described above, the display apparatus according to the present embodiment is a display apparatus, (a) which utilizes the Kerr effect that gives the display apparatus a high-speed responding property, and (b) in which large reduction in the temperature dependency of the display property is attained. Such display apparatus is practically significant.

Moreover, from the Example, it is obvious that the present invention attains a large Kerr constant B: for example, 500×10⁻¹⁰ cm/V² or more, specifically, 600×10⁻¹⁰ cm/V² to 900×10⁻¹⁰ cm/V², and keeps the variation of the Kerr constant B within not more than ±30% when the dielectric liquid is at a temperature in a range of from (a) the secondary phase transition temperature (T*) with respect to the liquid crystal-isotropic phase transition temperature, to (b) the temperature 5° C. higher than the secondary phase transition temperature (T*).

The Examples were so arranged that the electric field E was applied perpendicularly to the traveling direction of the light, for example, by using the comb-like shaped electrodes 24 and 25, which served as the electric-field-applying means (electric-field-applying member) for applying the electric field onto the dielectric liquid layer 41 in order to perform the display operation by utilizing the Kerr effect. However, the present invention is not limited to this. As long as the electric-field-applying means (electric-field-applying member) is capable of performing display operation by utilizing the Kerr effect, the electric-field-applying means (electric-field-applying member) is not particularly limited to any arrangement (electrode structure/configuration). Further, the Embodiments and the Examples are arranged such that the dielectric liquid layer 41 is sandwiched between a pair of substrates by introducing the dielectric liquid 6 into a gap between them, at least one of the substrates being transparent. However, the present invention is not limited to this. The dielectric liquid layer 41 does not need to be sandwiched between a pair of substrates. The dielectric liquid layer 41 may be held by using a member other than the substrates, the member being capable of holding the dielectric liquid 6. Moreover, the member may be flexible.

Moreover, the above description discusses, as an example of a display apparatus according to the present invention, the display apparatus that is so arranged that the dielectric liquid layer 41 contains the liquid crystal compound whose refractive index varies by the electric field applied thereon, the display apparatus performing the display operation by utilizing the secondary electro-optical effect (the refractive index varies in proportional to the square of the electric field). However, the present invention is not limited to this. The refractive index dose not need to vary in proportion to the square of the electric field, as long as the dielectric liquid layer 41 contains a liquid crystal compound whose optical anisotropy (refractive index, degree of alignment order) varies by application of an electric field, so that the dielectric liquid layer 41 can change its optical anisotropy by the electric field applied thereon. The display operation may utilize the Pockels effect, for example. The present invention is not particularly limited in terms of display method, provided that an arrangement in which an optical anisotropy is changed by application of an electric field, makes it possible to change display states by whether or not a voltage is applied. The dielectric liquid 6 is preferably such a medium that the medium has an optical isotropy (is optically isotropic (at least macroscopically optically isotropic)) when no electric field is applied, whereas when the electric field is applied the medium becomes optically anisotropic (typically, the medium is optically isotropic (at least macroscopically optically isotropic) when no electric field is applied, and is changed in its optical property when the electric field is applied (especially it is preferable that birefringence of the medium is increased when the electric field is applied)).

As described above, a display apparatus according to the present invention, which includes (a) a dielectric liquid layer being optically isotropic when no voltage is applied thereon, and having optical anisotropy that changes when an electric field is applied thereon, and (b) an electric-field-applying means (electric-field-applying member) for applying the electric field onto the dielectric liquid layer, the display apparatus performing display operation by changing an optical anisotropy by applying the electric field on the dielectric liquid layer, is so arranged that the dielectric liquid layer contains clusters at a temperature that is equal to or higher than a liquid crystal-isotropic phase transition temperature of the liquid crystal compound, and being transparent to visible light, the clusters formed by locally aligning liquid crystal molecules in the liquid crystal compound at the temperature that is equal to or higher than the liquid crystal-isotropic phase transition temperature of the liquid crystal compound.

More specifically, a display apparatus according to the present invention is, as described above, arranged as follows, for example: the display apparatus, which includes (a) a dielectric liquid layer containing a liquid crystal compound whose refractive index is changed by an electric field applied thereon; and (b) an electric-field-applying means (electric-field-applying member) for applying the electric field onto the dielectric liquid layer, the display apparatus performing display operation by using a secondary electro-optical effect in which the refractive index is in proportion with square of the electric field, is so arranged that the dielectric liquid layer contains clusters at a temperature that is equal to or higher than a liquid crystal-isotropic phase transition temperature of the liquid crystal compound, and is transparent to visible light, the clusters formed by locally aligning liquid crystal molecules in the liquid crystal compound at the temperature that is equal to or higher than the liquid crystal-isotropic phase transition temperature of the liquid crystal compound.

With the arrangement, in which even at a temperature equal to or higher than the liquid crystal-isotropic phase transition temperature of the liquid crystal compound, the dielectric liquid layer contains the clusters formed by locally aligning liquid crystal molecules in the liquid crystal compound, it is possible to reduce the temperature dependency of the Kerr effect. Moreover, with the arrangement, it is possible to provide a display apparatus that can be easily manufactured and has a high reliability, because there is no need of having, in order to reduce the temperature dependency of the Kerr effect, another arrangement that complicates production of the display apparatus, for example, the arrangement in which the region of the liquid material is divided into sub-regions.

As described above, the display apparatus of the present invention is preferably arranged such that the dielectric liquid layer has a Kerr constant that has a varying rate of not more than ±30% when the dielectric liquid layer is at a temperature in a range of from (a) the secondary phase transition temperature (T*) with respect to the liquid crystal-isotropic phase transition temperature, to (b) the temperature 5° C. higher than the secondary phase transition temperature (T*).

The secondary electro-optical effect, that is, the temperature dependency of the Kerr constant of the dielectric liquid layer, relates to the temperature dependency of the driving voltage. Therefore, with this arrangement, it is possible to provide a practical display apparatus in which the temperature dependency of the Kerr effect is reduced.

Moreover, as described above, the display apparatus of the present invention is preferably arranged such that the clusters contain a liquid crystal compound that is intermolecular-hydrogen-bonded. Further, as described above, the display apparatus of the present invention is arranged such that the clusters contain a liquid crystal compound having a smectic phase. Furthermore, as described above, the display apparatus of the present invention is preferably arranged such that the clusters are formed by using, as a core, a particulate having a particle diameter of 0.1 μm or less.

These arrangements give the cluster a long life even if the temperature is increased. Further, the arrangements can reduce the temperature dependency of the Kerr effect, even though the arrangements are so simple. Therefore, those arrangements make it possible to provide a display apparatus that can be easily manufactured.

Moreover, as described above, a display apparatus, which includes (a) a dielectric liquid layer containing a liquid crystal compound whose refractive index is changed by an electric field applied thereon, and (b) an electric-field-applying means (electric-field-applying member) for applying the electric field onto the dielectric liquid layer, the display apparatus performing display operation by using a secondary electro-optical effect in which the refractive index is in proportion with square of the electric field, is so arranged that the dielectric liquid layer is transparent to visible light and contains a liquid crystal compound having an ability of forming an intermolecular hydrogen bond.

More specifically, a display apparatus according to the present invention is, as described above, arranged as follows, for example: the display apparatus, which includes (a) a dielectric liquid layer containing a liquid crystal compound whose refractive index is changed by an electric field applied thereon, and (b) an electric-field-applying means (electric-field-applying member) for applying the electric field onto the dielectric liquid layer, the display apparatus performing display operation by using a secondary electro-optical effect in which the refractive index is in proportion with square of the electric field, is so arranged that the dielectric liquid layer is transparent to visible light and contains a liquid crystal compound having an ability of forming an intermolecular hydrogen bond.

With the arrangement, it is possible to give the clusters a large size, because the liquid crystal compound forms a hydrogen bond. Therefore, it is possible to attain a display apparatus in which the clusters are present even at a temperature equal to or higher than the liquid crystal-isotropic phase transition temperature of the liquid crystal compound, the clusters being formed by locally aligning the liquid crystal molecules of the liquid crystal compound. Hence, with the arrangement, it is possible to reduce the temperature dependency of the Kerr effect, and there is no need of having, in order to reduce the temperature dependency of the Kerr effect, another arrangement that complicates production of the display apparatus, for example, the arrangement in which the region of the liquid material is divided into sub-regions. Thus, this arrangement provides a display apparatus that can be easily produced and has a high reliability.

Moreover, as described above, the display apparatus of the present invention is preferably arranged such that the liquid crystal compound having the ability of forming the intermolecular hydrogen bond has a hydroxyl group.

The liquid crystal compound having a hydroxyl group, which is easy to obtain, has a short bond distance between the hydroxyl group and an oxygen atom, and thus has a large intermolecular interaction. Hence, this arrangement is effective in prolonging the life of the clusters even if the temperature rises, thereby sufficiently reducing the temperature dependency of the Kerr effect.

Moreover, as described above, a display apparatus according the present invention, which includes (a) a dielectric liquid layer being optically isotropic when no voltage is applied thereon, and having optical anisotropy that changes when an electric field is applied thereon, and (b) an electric-field-applying means (electric-field-applying member) for applying the electric field onto the dielectric liquid layer, the display apparatus performing display operation by changing an optical anisotropy by applying the electric field on the dielectric liquid layer, is so arranged that the dielectric liquid layer is transparent to visible light, and contains a liquid crystal compound having a smectic phase.

More specifically, a display apparatus according to the present invention is, as described above, arranged as follows, for example: the display apparatus according to the present invention, which includes (a) a dielectric liquid layer containing a liquid crystal compound whose refractive index is changed by an electric field applied thereon, and (b) an electric-field-applying means (electric-field-applying member) for applying the electric field onto the dielectric liquid layer, the display apparatus performing display operation by using a secondary electro-optical effect in which the refractive index is in proportion with square of the electric field, is so arranged that the dielectric liquid layer is transparent with respect to visible light, and contains a liquid crystal compound having a smectic phase.

Smectic liquid crystal compounds have a strong intermolecular interaction. The arrangement in which the dielectric liquid layer contains a smectic liquid crystal compound, gives the clusters a larger cluster size, and makes it possible to attain a display apparatus that has the clusters even at a temperature equal to or higher than the liquid crystal-isotropic phase transition temperature of the liquid crystal compound, the clusters formed by locally aligning liquid crystal molecules in the liquid crystal compound. Hence, with the arrangement, it is possible to reduce the temperature dependency of the Kerr effect, and there is no need of having, in order to reduce the temperature dependency of the Kerr effect, another arrangement that complicates production of the display apparatus, for example, the arrangement in which the region of the liquid material is divided into sub-regions. Thus, this arrangement provides a display apparatus that can be easily produced and has a high reliability.

Furthermore, the display apparatus of the present invention is preferably arranged such that the liquid crystal compound (smectic liquid crystal compound having the smectic phase has a cyano group as a terminal group thereof.

With the arrangement, it is possible to attain a better dipole moment, thereby attaining a larger Kerr effect.

Further, as described above, a display apparatus according to the present invention, which includes (a) a dielectric liquid layer being optically isotropic when no voltage is applied thereon, and having optical anisotropy that changes when an electric field is applied thereon, and (b) an electric-field-applying means (electric-field-applying member) for applying the electric field onto the dielectric liquid layer, the display apparatus performing display operation by changing an optical anisotropy by applying the electric field on the dielectric liquid layer, is so arranged that the dielectric liquid layer is transparent to visible light, and contains a particulate having a particle diameter of 0.1 μm or less, the particulate dispersed in the dielectric liquid layer.

More specifically, a display apparatus according to the present invention is, as described above, arranged as follows, for example: the display apparatus according to the present invention, which includes (a) a dielectric liquid layer containing a liquid crystal compound whose refractive index is changed by an electric field applied thereon; and (b) an electric-field-applying means (electric-field-applying member, for example, an electrode such as a comb-like shaped electrode or the like) for applying the electric field onto the dielectric liquid layer, the display apparatus performing display operation by using a secondary electro-optical effect in which the refractive index is in proportion with square of the electric field, is so arranged that the dielectric liquid layer is transparent to visible light, and contains a particulate having a particle diameter of 0.1 μm or less, the particulate dispersed in the dielectric liquid layer.

The scattering of light is ignorable when the particle diameter is 0.1 μm or less, that is, when the particle diameter of particles is smaller than a wavelength of incident light. Thus, when the particle diameter of the particulate is 0.1 μm or less, the particulate is transparent with respect to the visible light. When the dielectric liquid layer contains the particulate, it is easy for liquid crystal molecules to be adsorbed onto (oriented toward) a surface of the particulate physically or chemically, thereby being oriented toward the particulate as a core. Thereby, clusters having a large cluster size are attained. Hence, with this arrangement, it is possible to attain a display apparatus that has the clusters even at a temperature equal to or higher than the liquid crystal-isotropic phase transition temperature of the liquid crystal compound, the clusters formed by locally aligning liquid crystal molecules in the liquid crystal compound. Hence, with the arrangement, it is possible to reduce the temperature dependency of the Kerr effect, and there is no need of having, in order to reduce the temperature dependency of the Kerr effect, another arrangement that complicates production of the display apparatus, for example, the arrangement in which the region of the liquid material is divided into sub-regions. Thus, this arrangement provides a display apparatus that can be easily produced and has a high reliability.

Further, as described above, the display apparatus of the present invention is preferably so arranged as to include a dielectric thin film on at least one of surfaces of the dielectric liquid layer.

With this arrangement, in which a dielectric thin film is provided on at least one of surfaces of the dielectric liquid layer, it is possible to improve the degree of the order of the alignment of the liquid crystal, thereby attaining a larger Kerr effect.

Moreover, as described above, a display apparatus of the present invention, which includes (a) a dielectric liquid layer being optically isotropic when no voltage is applied thereon, and having optical anisotropy that changes when an electric field is applied thereon, and (b) an electric-field-applying means (electric-field-applying member) for applying the electric field onto the dielectric liquid layer, the display apparatus performing display operation by changing an optical anisotropy by applying the electric field on the dielectric liquid layer, is so arranged that the dielectric liquid layer is transparent to visible light, and contains a particulate having a particle diameter of 0.1 μm or less, the particulate dispersed in the dielectric liquid layer.

More specifically, a display apparatus according to the present invention is, as described above, arranged as follows, for example: the display apparatus according to the present invention, which includes (a) a dielectric liquid layer containing a liquid crystal compound whose refractive index is changed by an electric field applied thereon; and (b) an electric-field-applying means (electric-field-applying member, for example, an electrode such as a comb-like shaped electrode or the like) for applying the electric field onto the dielectric liquid layer, the display apparatus performing display operation by using a secondary electro-optical effect in which the refractive index is in proportion with square of the electric field, is so arranged that the dielectric liquid layer is transparent to visible light, and contains a particulate having a particle diameter of 0.1 μm or less, the particulate dispersed in the dielectric liquid layer.

As described above, the scattering of light is ignorable when the particle diameter is 0.1 μm or less, that is, when the particle diameter of particles is smaller than a wavelength of incident light. Thus, when the particle diameter of the particulate is 0.1 μm or less, the particulate is transparent with respect to the visible light.

Because the dielectric thin layer, which touches at least one of surfaces of the dielectric liquid layer, contains the particulate, this arrangement makes it possible to attain a display apparatus that has the clusters even at a temperature equal to or higher than the liquid crystal-isotropic phase transition temperature of the liquid crystal compound, the clusters formed by locally aligning liquid crystal molecules in the liquid crystal compound. Hence, with the arrangement, it is possible to reduce the temperature dependency of the Kerr effect, and there is no need of having, in order to reduce the temperature dependency of the Kerr effect, another arrangement that complicates production of the display apparatus, for example, the arrangement in which the region of the liquid material is divided into sub-regions. Thus, this arrangement provides a display apparatus that can be easily produced and has a high reliability.

Further, as described above, the display apparatus of the present invention is preferably arranged such that the dielectric thin film is an organic thin film.

This arrangement, in which the display apparatus has the dielectric thin film that is an organic thin film, is effective for attaining good alignment, thereby attaining a greater degree of alignment order of the liquid crystal, and a larger Kerr effect.

Furthermore, as described above, the display apparatus of the present invention is preferably arranged such that the organic thin film is a polyimide thin film.

The polyimide thin film is excellently effective for attaining a good alignment. Thus, this arrangement attains further improves the degree of the alignment order of the liquid crystal. Therefore, with this arrangement, it is possible to attain a greater Kerr effect stably. Moreover, polyimide is a quite stable material and highly reliable. Thus, the use of polyimide makes it possible to provide a display apparatus having a good display performance.

Furthermore, as described above, the display apparatus of the present invention is preferably arranged such that the particulate has palladium on a surface thereof.

With this arrangement, in which the particulate has palladium on a surface thereof., it is easy for the liquid crystal molecules to be adsorbed onto the surface of the particulate physically or chemically, thereby obtaining the clusters having a large size, and having a long life even if the temperature rises.

Moreover, as described above, the display apparatus of the present invention is preferably arranged such that the dielectric liquid layer has a cyano group as a terminal group thereof.

With this arrangement, in which the dielectric liquid layer has a cyano group as a terminal group thereof, the formation of the clusters becomes easy. As a result, it becomes possible to form clusters having a large cluster size and a long life.

Further, as described above, the display apparatus of the present invention is arranged such that the electric-field-applying means (electric-field-applying member) is a comb-like shaped electrode formed on at least one of surfaces of the dielectric liquid layer.

With this arrangement, it is possible to easily apply the electric field in the direction that is perpendicular to the light that perpendicularly passes the surface of the dielectric layer, that is, it is possible to easily apply the electric field in the direction that is parallel to the surface of the dielectric layer. Thus, it is possible to easily extract, as a change in the optical signal, the birefringence anisotropy generated by the application of the electric field.

Furthermore, as described above, the display apparatus of the present invention is preferably so arranged as to further include a heating means (heating member) for heating the dielectric liquid layer to a temperature equal to or higher than the liquid crystal-isotropic phase transition temperature of the liquid crystal compound.

With this arrangement, it is possible to cause the isotropic phase transition of the liquid crystal compound even if the liquid crystal compound has a liquid crystal phase at room temperature, that is, even if the liquid crystal compound has an isotropic phase transition temperature higher than the room temperature. Therefore, it is possible to easily obtain a liquid that is transparent with respect to the visible light but is macroscopically isotropic.

The above-described embodiments are not to limit the present invention, which may be modified in various ways within a scope of the claims below. The technical scope of the present invention includes embodiments obtained by appropriately combining the arrangements disclosed in the different embodiments.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

1. A display apparatus comprising (a) a dielectric liquid layer containing a liquid crystal compound whose refractive index is changed by an electric field applied thereon; and (b) an electric-field-applying member for applying the electric field onto the dielectric liquid layer, the display apparatus performing display operation by using a secondary electro-optical effect in which the refractive index is in proportion with square of the electric field, wherein:
the dielectric liquid layer contains clusters at a temperature that is equal to or higher than a liquid crystal-isotropic phase transition temperature of the liquid crystal compound, and is transparent to visible light, the clusters formed by locally aligning liquid crystal molecules in the liquid crystal compound at the temperature that is equal to or higher than the liquid crystal-isotropic phase transition temperature of the liquid crystal compound.

2. The display apparatus as set forth in claim 1, wherein the dielectric liquid layer has a Kerr constant that has a varying rate of not more than ±30% when the dielectric liquid layer is at a temperature in a range of from (a) the secondary phase transition temperature (T*) with respect to the liquid crystal-isotropic phase transition temperature, to (b) the temperature 5° C. higher than the secondary phase transition temperature (T*).

3. The display apparatus as set forth in claim 1, wherein:
the clusters contain a liquid crystal compound that is intermolecular-hydrogen-bonded.

4. The display apparatus as set forth in claim 1, wherein:
the clusters contain a liquid crystal compound having a smectic phase.

5. The display apparatus as set forth in claim 1, wherein:
the clusters are formed by using, as a core, a particulate having a particle diameter of 0.1 μm or less.

6. The display apparatus as set forth in claim 1, comprising:
a dielectric thin film on at least one of surfaces of the dielectric liquid layer.

7. The display apparatus as set forth in claim 6, wherein:
the dielectric thin film is an organic thin film.

8. The display apparatus as set forth in claim 7, wherein:
the organic thin film is a polyimide thin film.

9. The display apparatus as set forth in claim 1, wherein:
the electric-field-applying member is a comb-like shaped electrode formed on at least one of surfaces of the dielectric liquid layer.

10. The display apparatus as set forth in claim 1, further comprising:
a heating member for heating the dielectric liquid layer to a temperature equal to or higher than the liquid crystal-isotropic phase transition temperature of the liquid crystal compound.

11. A display apparatus comprising (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, wherein:
the dielectric liquid layer contains clusters at a temperature that is equal to or higher than a liquid crystal-isotropic phase transition temperature of the liquid crystal compound, and is transparent to visible light, the clusters formed by locally aligning liquid crystal molecules in the liquid crystal compound at the temperature that is equal to or higher than the liquid crystal-isotropic phase transition temperature of the liquid crystal compound.

12. A display apparatus comprising (a) a dielectric liquid layer containing a liquid crystal compound whose refractive index is changed by an electric field applied thereon, and (b) an electric-field-applying member for applying the electric field onto the dielectric liquid layer, the display apparatus performing display operation by using a secondary electro-optical effect in which the refractive index is in proportion with square of the electric field, wherein:
the dielectric liquid layer is transparent to visible light and contains a liquid crystal compound having an ability of forming an intermolecular hydrogen bond.

13. The display apparatus as set forth in claim 12, wherein:
the liquid crystal compound having the ability of forming the intermolecular hydrogen bond has a hydroxyl group.

14. The display apparatus as set forth in claim 12 comprising:
a dielectric thin film on at least one of surfaces of the dielectric liquid layer.

15. The display apparatus as set forth in claim 14, wherein:
the dielectric thin film is an organic thin film.

16. The display apparatus as set forth in claim 15, wherein:
the organic thin film is a polyimide thin film.

17. The display apparatus as set forth in claim 12, wherein:
the electric-field-applying member is a comb-like shaped electrode formed on at least one of surfaces of the dielectric liquid layer.

18. The display apparatus as set forth in claim 12, further comprising:
a heating member for heating the dielectric liquid layer to a temperature equal to or higher than the liquid crystal-isotropic phase transition temperature of the liquid crystal compound.

19. A display apparatus comprising (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, wherein:
the dielectric liquid layer is transparent to visible light and contains a liquid crystal compound having an ability of forming an intermolecular hydrogen bond.

20. A display apparatus comprising (a) a dielectric liquid layer containing a liquid crystal compound whose refractive index is changed by an electric field applied thereon, and (b) an electric-field-applying member for applying the electric field onto the dielectric liquid layer, the display apparatus performing display operation by using a secondary electro-optical effect in which the refractive index is in proportion with square of the electric field, wherein:
the dielectric liquid layer is transparent with respect to visible light, and contains a liquid crystal compound having a smectic phase.

21. The display apparatus as set forth in claim 20, wherein:
the liquid crystal compound having the smectic phase has a cyano group as a terminal group thereof.

22. The display apparatus as set forth in claim 20, comprising:
a dielectric thin film on at least one of surfaces of the dielectric liquid layer.

23. The display apparatus as set forth in claim 22, wherein:
the dielectric thin film is an organic thin film.

24. The display apparatus as set forth in claim 23, wherein:
the organic thin film is a polyimide thin film.

25. The display apparatus as set forth in claim 20, wherein:
the electric-field-applying member is a comb-like shaped electrode formed on at least one of surfaces of the dielectric liquid layer.

26. The display apparatus as set forth in claim 20, comprising:
a heating member for heating the dielectric liquid layer to a temperature equal to or higher than the liquid crystal-isotropic phase transition temperature of the liquid crystal compound.

27. A display apparatus comprising (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, wherein:
the dielectric liquid layer is transparent to visible light, and contains a liquid crystal compound having a smectic phase.

28. A display apparatus comprising (a) a dielectric liquid layer containing a liquid crystal compound whose refractive index is changed by an electric field applied thereon; and (b) an electric-field-applying member for applying the electric field onto the dielectric liquid layer, the display apparatus performing display operation by using a secondary electro-optical effect in which the refractive index is in proportion with square of the electric field, wherein:
the dielectric liquid layer is transparent to visible light, and contains a particulate having a particle diameter of 0.1 μm or less, the particulate dispersed in the dielectric liquid layer.

29. The display apparatus as set forth in claim 28, comprising:
a dielectric thin film on at least one of surfaces of the dielectric liquid layer.

30. The display apparatus as set forth in claim 29, wherein:
the dielectric thin film is an organic thin film.

31. The display apparatus as set forth in claim 30, wherein:
the organic thin film is a polyimide thin film.

32. The display apparatus as set forth in claim 28, wherein:
the particulate has palladium on a surface thereof.

33. The display apparatus as set forth in claim 28, wherein:
the dielectric liquid layer has a cyano group as a terminal group thereof.

34. The display apparatus as set forth in claim 28, wherein:
the electric-field-applying member is a comb-like shaped electrode formed on at least one of surfaces of the dielectric liquid layer.

35. The display apparatus as set forth in claim 28, further comprising:
a heating member for heating the dielectric liquid layer to a temperature equal to or higher than the liquid crystal-isotropic phase transition temperature of the liquid crystal compound.

36. A display apparatus comprising (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, wherein:
the dielectric liquid layer is transparent to visible light, and contains a particulate having a particle diameter of 0.1 μm or less, the particulate dispersed in the dielectric liquid layer.

37. A display apparatus comprising (a) a dielectric liquid layer containing a liquid crystal compound whose refractive index is changed by an electric field applied thereon; and (b) an electric-field-applying member for applying the electric field onto the dielectric liquid layer, the display apparatus performing display operation by using a secondary electro-optical effect in which the refractive index is in proportion with square of the electric field, wherein:
the dielectric liquid layer is transparent to visible light; and
a dielectric thin film is provided on at least one of surfaces of the dielectric liquid layer so that the dielectric thin film touches the at least one of the surfaces, the dielectric thin film containing a particulate having a particle diameter of 0.1 μm or less.

38. The display apparatus as set forth in claim 37, wherein:
the dielectric thin film is an organic thin film.

39. The display apparatus as set forth in claim 38, wherein:
the organic thin film is a polyimide thin film.

40. The display apparatus as set forth in claim 37, wherein:
the particulate has palladium on a surface thereof.

41. The display apparatus as set forth in claim 37, wherein:
the liquid crystal compound having the smectic phase has a cyano group as a terminal group thereof.

42. The display apparatus as set forth in claim 37, wherein:
the electric-field-applying member is a comb-like shaped electrode formed on at least one of surfaces of the dielectric liquid layer.

43. The display apparatus as set forth in claim 37, comprising:
a heating member for heating the dielectric liquid layer to a temperature equal to or higher than the liquid crystal-isotropic phase transition temperature of the liquid crystal compound.

44. A display apparatus comprising (a) a dielectric liquid layer being optically isotropic when no voltage is applied thereon, and having optical anisotropy that changes when an electric field is applied thereon, and (b) an electric-field-applying member for applying the electric field onto the dielectric liquid layer, the display apparatus performing display operation by changing an optical anisotropy by applying the electric field on the dielectric liquid layer, wherein:
the dielectric liquid layer is transparent to visible light; and
a dielectric thin film is provided on at least one of surfaces of the dielectric liquid layer so that the dielectric thin film touches the at least one of the surfaces, the dielectric thin film containing a particulate having a particle diameter of 0.1 μm or less.
